(19) United States
(12) Patent Application Publication
(10) Pub. No.: US 2005/0009889 A1
(43) Pub. Date: Jan. 13, 2005

(54) Synergistic fungicide compositions containing at least one n-(2-pyridinyl) 1-3-pyridinecarboxamide derivative and one or more further fungicides useful for controlling fungal plant diseases

(76) Inventors: Stephen Ray Foor, Hockessin, DE (US); Michael Paul Walker, Landenberg, PA (US)

Correspondence Address: EI Du Pont de Nemours and Company;Legal - Patents, 4417 Lancaster Pike, Wilmington, DE, 19805, US

(21) Appl. No.: 10/501,853

(22) PCT Filed: Mar. 18, 2003
(86) PCT No.: PCT/US03/08186

Related U.S. Application Data
(60) Provisional application No. 60/365,766, filed on Mar. 19, 2002.

(51) Int. Cl. A01N 43/40; A01N 47/10

(52) U.S. Cl. 514/357; 514/483

(57) ABSTRACT

Compositions for controlling plant diseases caused by fungal plant pathogens are described, comprising: (a) at least one compound of Formula I, including all geometric and stereoisomers, N-oxides and agriculturally suitable salts thereof: I—wherein R1, R₂, R₅ and R₆, m and n are as defined in the disclosure; and (b) at least one compound selected from the group consisting of (b1) alkylenebis(dithiocarbamate) fungicides; (b2) compounds acting at the bc₁ complex of the fungal mitochondrial respiratory electron transfer site; (b3) cymoxanil; (b4) compounds acting at the demethylase enzyme of the sterol biosynthesis pathway; (b5) morpholine and piperidine compounds that act on the sterol biosynthesis pathway; (b6) phenylamide fungicides; (b7) pyrimidinone fungicides; (b8) phthalimides; and (b9) fosetyl-aluminum. Also disclosed are methods for controlling plant diseases caused by fungal plant pathogens that involves applying an effective amount of the combinations described.

### BACKGROUND OF THE INVENTION

This invention relates to certain pyridinyl amides, their N-oxides, agriculturally suitable salts, certain advantageous compositions containing a mixture of pyridinyl amides and other fungicides and methods of their use as fungicides.

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new products that are more effective, less costly, less toxic, or environmentally safer.

WO 01/11966 discloses certain pyridinyl amides of formula i as fungicides 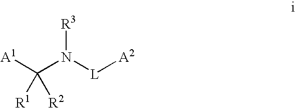
wherein, among others,
A¹ is 2-pyridyl substituted by up to four groups at least one of which is haloalkyl,
A² is optionally substitted heterocyclyl;
R¹ and R² are independently H, allyl or acyl;
R³ is H or alkyl; and
L is —(C═O)—, —SO₂— or —(C═S)—.

Fungicides that effectively control plant fungi, particularly of the class Oomycetes, such as Phytophthora spp. and Plasmopara spp., are in constant demand by growers. Combinations of fungicides are often used to facilitate disease control and to retard resistance development. It is desirable to enhance the activity spectrum and the efficacy of disease control by using mixtures of active ingredients that provide a combination of curative, systemic and preventative control of plant pathogens. Also desirable are combinations that provide greater residual control to allow for extended spray intervals. It is also very desirable to combine fungicidal agents that inhibit different biochemical pathways in the fungal pathogens to retard development of resistance to any one particular plant disease control agent.

It is in all cases particularly advantageous to be able to decrease the quantity of chemical agents released in the environment while ensuring effective protection of crops from diseases caused by plant pathogens. Lures of fungicides may provide significantly better disease control than could be predicted based on the activity of the individual components. This synergism has been described as “the cooperative action of two components of a mixture, such that the total effect is greater or more prolonged than the sum of the effects of the two (or more) taken independently” (see Tames, P. M. L., Neth. J. Plant Pathology, (1964), 70, 73-80).

There is a desire to find fungicidal agents that are particularly advantageous in achieving one or more of the preceding objectives.

### SUMMARY OF THE INVENTION

This invention provides a composition for controlling plant diseases caused by fungal plant pathogens comprising (a) at least one compound of Formula I (including all geometric and stereoisomers), N-oxides and agriculturally suitable salts thereof: 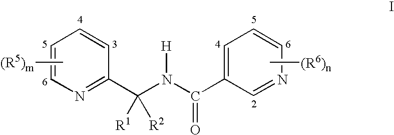
wherein
R¹ and R² are each independently H or C₁-C₆ alkyl;
each R⁵ is independently C₁-C₆ alkyl; C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl; provided that at least one R⁵ is C₁ to C₆ haloalkyl;
each R⁶ is independently C₁-C₆ alkyl, C₂-C₆ alkenyl, C₂-C₆ alkyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl; and
m and n are independently 1, 2, 3 or 4; and
(b) at least one compound selected from the group consisting of
(b1) alkylenebis(dithiocarbamate) fungicides;
(b2) compounds acting at the bc₁ complex of the fungal mitochondrial respiratory electron transfer site;
(b3) cymoxanil;
(b4) compounds acting at the demethylase enzyme of the sterol biosynthesis pathway;
(b5) morpholine and piperidine compounds that act on the sterol biosynthesis pathway;
(b6) phenylamide fungicides;
(b7) pyrimidinone fungicides;
(b8) phthalimides; and
(b9) fosetyl-aluminum.

This invention also relates to a method for controlling plant diseases caused by fungal plant pathogens comprising applying to the plant or portion thereof, or to the plant seed or seedling, a fungicidally effective amount of a composition of the invention.

### DETAILS OF THE INVENTION

In the above recitations, the term “alkyl”, used either alone or in compound words such as “alkylthio” or “haloalkyl” includes straight-chain or branched alkyl, such as, methyl, ethyl, n-propyl, i-propyl, or the different butyl, pentyl or hexyl isomers. “Alkenyl” includes straight chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkoxyalkoxy” denotes alkoxy substitution on alkoxy. The term “Alkenyloxy” includes straight chain or branched alkenyloxy moieties. Examples of “alkenyloxy” include H₂C═CHCH₂O, (CH₃)₂C═CHCH₂O, (CH₃)CH═CHCH₂O, (CH₃)CH═C(CH₃)CH₂O and CH₂═CHCH₂CH₂O. “Alkynyloxy” includes straight chain or branched alkynyloxy moieties. Examples of “alkynyloxy” include HC≡CCH₂O, CH₃C≡CCH₂O and CH₃C≡CCH₂CH₂O. “Alkylthio” includes branched or straight chain alkylthio moieties such as methylthio, ethylthio, and the different propylthio, butylthio, pentylthio and hexylthio isomers. “Alkylsulfinyl” includes both enantiomers of an alkylsulfinyl group. Examples of “alkylsulfinyl” include CH₃S(O), CH₃CH₂S(O), CH₃CH₂CH₂S(O), (CH₃)₂CHS(O) and the different butylsulfinyl pentylsulfinyl and hexylsulfinyl isomers. Examples of “alkylsulfonyl” include CH₃S(O)₂, CH₃CH₂S(O)₂, CH₃CH₂CH₂S(O)₂, (CH₃)₂CHS(O)₂ and the different butylsulfonyl pentylsulfonyl and hexylsulfonyl isomers. “Alkylamino”, “dialkylamino”, “alkenylthio”, “alkenylsulfinyl”, “alkenylsulfonyl”, “alkynylthio”, “alkynylsulfinyl”, “alkynylsulfonyl”, and the like, are defined analogously to the above examples. “Cycloalkyl” includes, for example, cyclopropyl, cyclobutyl, cyclopentyl, and cyclohexyl. The term “cycloalkoxy” includes the same groups linked through an oxygen atom such as cyclopentyloxy and cyclohexyloxy.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkynyl”, “haloalkoxy”, “haloalkylthio”, and the like, are defined analogously to the term “haloalkyl”. Examples of “haloalkenyl” include (Cl)₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, HCF₂CH₂CH₂O and CF₃CH₂O. Examples of “haloalkylthio” include CCl₃S, CF₃S, CCl₃CH₂S and ClCH₂CH₂CH₂S. Examples of “haloalkylsulfinyl” include CF₃S(O), CCl₃S(O), CF₃CH₂S(O) and CF₃CF₂S(O). Examples of “haloalkylsulfonyl” include CF₃S(O)₂, CCl₃S(O)₂, CF₃CH₂S(O)₂ and CF₃CF₂S(O)₂. Examples of “haloalkoxyalkoxy” include CF₃OCH₂O, ClCH₂CH₂OCH₂CH₂O, Cl₃CCH₂OCH₂O as well as branched alkyl derivatives. Examples of “alkylcarbonyl” include C(O)CH₃, C(O)CH₂CH₂CH₃ and C(O)CH(CH₃)₂. Examples of “alkoxycarbonyl” include CH₃OC(═O), CH₃CH₂C(═O), CH₃CH₂CH₂C(═O), (CH₃)₂CHOC(═O) and the different butoxy- or pentoxycarbonyl isomers.

One skilled in the art will appreciate that not all nitrogen containing heterocycles can form N-oxides since the nitrogen requires an available lone pair for oxidation to the oxide; one skilled in the art will recognize those nitrogen containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed, Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The total number of carbon atoms in a substituent group is indicated by the “Cᵢ-Cⱼ” prefix where i and j are numbers from 1 to 8. For example, C₁-C₃ alkylsulfonyl designates methylsulfonyl through propylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂.

When a compound is substituted with a substituent bearing a subscript that indicates the number of said substituents can exceed 1, said substituents (when they exceed 1) are independently selected from the group of defined substituents. Further, when the subscript indicates a range, e.g. (R)ᵢ₋ⱼ, then the number of substituents may be selected from the integers between i and j inclusive.

When a group contains a substituent which can be hydrogen, for example R¹ or R² then, when this substituent is taken as hydrogen, it is recognized that this is equivalent to said group being unsubstituted.

Compounds of Formula I can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the present invention comprises compounds selected from Formula I, N-oxides and agriculturally suitable salts thereof. The compounds of Formula I may be present as a mixture of stereoisomers, individual stereoisomers, or as an optically active form. In particular, when R¹ and R² of Formula I are different, then said Formula possesses a chiral center at the carbon to which R¹ and R² are commonly bonded.

This invention includes racemic mixtures of equal parts of Formula I′ and Formula I″. 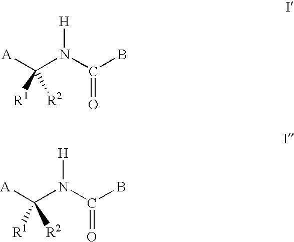
wherein A is a 2-pyridinyl group substituted with (R⁵)ₘ and B is a 3-pyridinyl group substituted with (R⁶)ₙ, and R⁵, R⁶, m and n are as defined above.

In addition, this invention includes compositions that are enriched compared to the racemic mixture in an enantiomer of the Formula I′ or Formula I″. This invention also includes compositions wherein component (a) is enriched in a component (a) enantiomer of Formula I′ compared to the racemic mixture of component (a). Included are compositions comprising the essentially pure enantiomers of Formula I′. This invention also includes compositions wherein component (a) is enriched in a component (a) enantiomer of Formula I″ compared to the racemic mixture of component (a). Included are compositions comprising the essentially pure enantiomers of Formula I″.

When enantiomerically enriched, one enantiomer is present in greater amounts that the other and the extent of enrichment can be defined by an expression of enantiomer excess (“ee”), which is defined as 100(2x−1) where x is the mole fraction of the dominant enantiomer in the enantiomer mixture (e.g., an ee of 20% corresponds to a 60:40 ratio of enantiomers).

The more active enantiomer with respect to the relative positions of R¹, R², A and the rest of the molecule bonded through nitrogen corresponds to the configuration of the enantiomer of 2,4-dichloro-N-[(1R)-1-[3-chloro-5-(trifluoromethyl)-2-pyridinyl]ethyl]-3-pyridinecarboxamide that, when in a solution of CDCl₃, rotates plane polarized light in the (+) or dextro direction (i.e. the predominant enantiomer of Compound 22 of Index Table A).

Preferably there is at least a 50% enantiomeric excess; more preferably at least a 75% enantiomeric excess; still more preferably at least a 90% enantiomeric excess; and the most preferably at least a 94% enantiomeric excess of the more active isomer of Formula I. Of particular note are enantiomerically pure embodiments of the more active isomer of Formula I.

The salts of the compounds of Formula I include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. The salts of the compounds of Formula I also include those formed with organic bases (e.g., pyridine, ammonia, or triethylamine) or inorganic bases (e.g., hydrides, hydroxides, or carbonates of sodium, potassium, lithium, calcium, magnesium or barium) when the compound contains an acidic group such as a carboxylic acid or phenol.
Preferred compositions of the invention, wherein (a) comprises compounds of Formula I, for reasons of better activity and/or ease of synthesis are:
Preferred 1. Preferred are compositions wherein in Formula I at least one R⁶ located in a position ortho to the Link with C═O.
Preferred 2. Compositions of Preferred 1 wherein there is an R⁶ at each position ortho to the link with C═O, and optionally 1 to 2 additional R⁶ and R⁶ is either halogen or methyl.

Of note are compositions wherein in Formula I at least one R⁶ is iodo.
Preferred 3. Compositions of Preferred 2 wherein one R⁶ is a Cl located at the 2-position ortho to the link with C═O, another R⁶ is selected from Cl or methyl and is located at the 4-position ortho to the link with C═O and a third optional R⁶ is methyl at the 6-position.

Preferred compositions of this invention include those of Preferred 1 through Preferred 3 wherein one R⁵ is 3-chloro and a second R⁵ is 5-CF₃.

Preferred compositions of this invention include those of Preferred 1 through Preferred 3 wherein R¹ is H and R² is H or CH₃. More preferred are compositions of Preferred 1 through Preferred 3 wherein R¹ is H and R² is CH₃.

Specifically preferred are compositions comprising a compound selected from the group consisting of
2,4-Dichloro-N-[[3-chloro-5-(trifluoromethyl)-2-pyridinyl]methyl]-3-pyridinecarboxamide,
2,4-Dichloro-N-[1-[3-chloro-5-(trifluoromethyl)-2-pyridinyl]ethyl]-3-pyridinecarboxamide,
2,4-Dichloro-N-[[3-chloro-5-(trifluoromethyl)-2-pyridinyl]methyl]-6-methyl-3-pyridinecarboxamide, and
2,4-Dichloro-N-[1-[3-chloro-5-(trifluoromethyl)-2-pyridinyl]ethyl]-6-methyl-3-pyridinecarboxamide.

This invention also relates to a method for controlling plant diseases caused by fungal plant pathogens comprising applying to the plant or portion thereof, or to the plant seed or seedling, a fungicidally effective amount of the composition of the invention (i.e., as a composition described herein). The preferred methods of use are those involving the above-preferred compositions.

The compounds of Formula I can be prepared by one or more of the following methods and variations as described in Schemes 1-5. The definitions of A, B, R¹ through R⁶ and n in the compounds of Formulas 1-4 below are as defined above. Compounds of Formula 1a, 1b and 1c are subsets of Formula 1. Compounds of Formulae Ia, Ib and Ic are subsets of the compounds of Formula I, and all substituents for Formulae Ia, Ib and Ic are as defined above for Formula I.

As shown in Scheme 1, the compounds of Formula Ia can be prepared by treating amine salts of Formula 1 with an appropriate acid chloride in an inert solvent with two molar equivalents of a base (e.g. triethylamine or potassium carbonate) present. Suitable solvents are selected from the group consisting of ethers such as tetrahydrofuran, dimethoxyethane, or diethyl ether; hydrocarbons such as toluene or benzene; and halocarbons such as dichloromethane or chloroform.

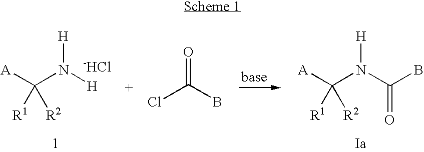

As depicted in Scheme 2, compounds of Formula Ia can be alternatively synthesized by reacting the amine salts of Formula 1 with an appropriate carboxylic acid in the presence of an organic dehydrating reagent such as 1,3-dicyclohexylcarbodiimide (DCC) or 1-[3-(Dimethylamino)propyl]-3-ethylcarbodiimide hydrochloride (EDC). Suitable solvents are selected from the group consisting of ethers such as tetrahydrofuran, dimethoxyethane, or diethyl ether; hydrocarbons such as toluene or benzene; and halocarbons such as dichloromethane or chloroform.

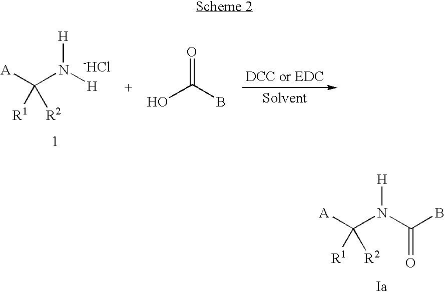

As show in Scheme 3, the amine salts of Formula 1a, wherein A is 2-pyridyl bearing the indicated substituents and R¹ and R² are hydrogen, can be prepared by reacting the commercially available imine ester 5 with a 2,3-dichloro-pyridine of Formula 4 in the presence of a strong base such as sodium hydride in a polar, aprotic solvent such as N,N-dimethylformamide followed by heating in acidic medium in a procedure analogous to those found in WO99/42447. Compounds of Formula 1b can be prepared by similar procedures in which the intermediate anion resulting from step 1 is treated with an alkylating agent R²—X such as methyl iodide prior to heating in an acidic medium. In the alkylating reagent R²—X, X is a suitable leasing group such as halogen (e.g., Br, I), OS(O)₂CH₃ (methanesulfonate), OS(O)₂CF₃, OS(O)₂Ph-p-CH₃ (p-toluenesulfonate), and the like; methanesulfonate works well. Of note are compounds of 1a, 1b and 4 wherein R⁵ is CF₃.

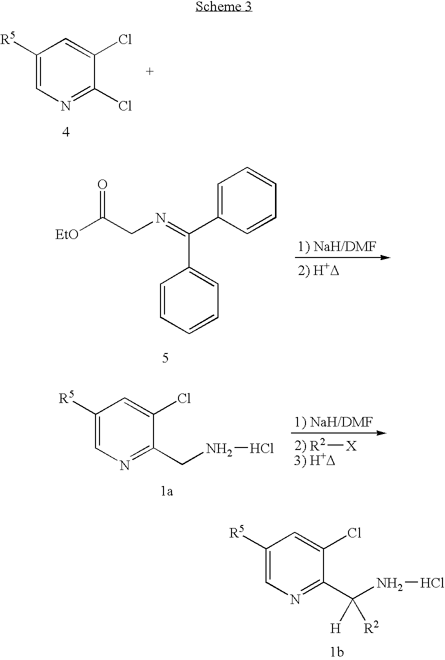

As shown in Scheme 4, compounds of Formula 1c (wherein A is a substituted 2-pyridinyl ring), bearing an aminomethyl group, can be synthesized from nitriles of Formula 2 (wherein A is a substituted 2-pyridinyl ring) by reduction of the nitrile using lithium aluminum hydride (LAH) in toluene. 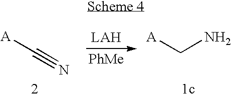
A is a substituted 2-pyridinyl ring

As shown in Scheme 5, compounds of Formula 1c (wherein A is a substituted 2-pyridinyl ring) can be alternatively synthesized by reacting compounds of Formula 3 with ammonia in a protic solvent such as methanol to provide compounds of Formula 1c. Compounds of Formula 1c can also be prepared by reacting compounds of Formula 3 with a potassium salt of phthalimide followed by reaction with either aminoethanol or hydrazine in an alcohol solvent to provide the desired aminomethyl intermediates of Formula 1c.

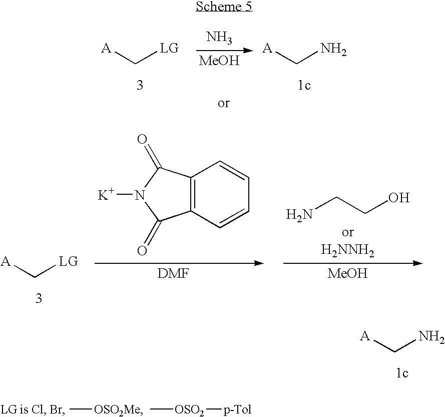

It is recognized that some reagents and reaction conditions described above for preparing compounds of Formula I may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula I. One skilled in the art will also recognize that it may be necessary to perform a combination of the steps illustrated in the above schemes in an order other than that implied by the particular sequence presented to prepare the compounds of Formula I.

One skilled in the art will also recognize that compounds of Formula I and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can prepare compounds comprising component (a) of the present invention to its fullest eat. The following Examples are, therefore, to be construed as merely illustrative, and not limiting of the disclosure in any way whatsoever. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; s is singlet, d is doublet, t is triplet, q is quartet, m is multiplet, dd is doublet of doublets, dt is doublet of triplets, br s is broad singlet.

### EXAMPLE 1

### Preparation of 2,4-Dichloro-N-[[3-chloro-5-(trifluoromethyl)-2-2-pyridinyl]methyl]-6-methyl-3-pyridinecarboxamide

Step A: Preparation of 2,4-Dichloro-N-[[3-chloro-5-(trifluoromethyl)-2-pyridinyl]methyl]-6-methyl-3-pyridinecarboxamide

To a solution of 2,4-dichoro-6-methyl-3-pyridine carbonyl chloride (0.65 g) in 2 mL of dichloromethane was added a solution of 2-aminomethyl-3-chloro-5-trifluoromethylpyridine hydrochloride (prepared as described in WO99/42447) (0.79 g) and triethylamine (0.68 g) in 10 mL of dichloromethane at room temperature. The reaction mixture was stirred at room temperature overnight. The reaction mixture was then poured on top of a one-inch silica gel plug, eluted with 30 mL of dichloromethane and the eluent was concentrated to yield 0.69 g of the title compound, a compound of the present invention.

¹H NMR (CDCl₃) δ 2.57 (s,3H), 4.96 (m,2H), 7.22 (s,1H), 7.48 (bs, 1H), 8.00 (s,1H), 8.71 (s,1H).

### EXAMPLE 2

### Preparation of 2,4-Dichloro-N-[[3-chloro-5-(trifluoromethyl)-2-pyridinyl]methyl]-3-pyridinecarboxamide

Step A Preparation of 2,4-dichloropyridine

A solution of 6.7 g of 4-nitropyridine N-oxide in POCl₃ was refluxed for 3 hours and then cooled to room temperature. The solvent was removed under vacuum to leave an oily residue. Saturated aqueous sodium bicarbonate solution (200 mL) was carefully added, followed by extraction with dichloromethane (2×). The dichloromethane was then removed under vacuum to provide an oil that was filtered through a plug of silica gel, eluting with 20% ethyl acetate in hexanes. Removal of the solvent under vacuum left 1.6 g of an oil.

¹H NMR (CDCl₃) δ 7.25(dd,1H, J=1.7 and 5.4 Hz), 7.38(d,1H, J=1.7 Hz), 8.31(d,1H, J=5.4 Hz).

Step B: Preparation of 2,4-dichloro-3-pyridine carboxaldehyde

To a solution of 1.6 g of 2,4-dichloropyridine (i.e. the product of Step A) in 5 mL dry tetrahydrofuran was added a solution of 6 mL of lithium diisopropyl amide in 25 mL of tetrahydrofuran at −70° C. under nitrogen. After stirring at −70° C. for 3 hours, 1 mL of dry N,N-dimethylformamide was added followed by stirring at this temperature for 1 hour. Then 25 mL of saturated aqueous ammonium chloride solution was added and the reaction mixture was stirred at room temperature overnight. The reaction mixture was diluted with 25 mL of water and extracted with ethyl acetate (2×). The combine organic extracts were distilled under vacuum to give solids that were dissolved in 5 mL of dichloromethane and filtered through silica gel, eluting with 100% methylene chloride. Removal of the solvent under vacuum provided the title compound as a solid.

¹H NMR (CDCl₃) δ 7.41 (d,1H, J=5.3 Hz), 8.42 (d,1H, J=5.2 Hz), 10.5 (s,1H).

Step C: Preparation of 2,4-dichloronicotinic acid

To a solution of 0.40 g of 2,4-dichloro-3-pyridine carboxaldehyde (i.e. the product of Step B in 6 mL of tetrahydrofuran was added a solution of 0.27 g of sodium chlorite and 0.29 g of sulfamic acid in 6 mL of water. The reaction mixture was stirred at room temperature overnight. The reaction mixture was diluted with 1 N aqueous sodium hydroxide (10 mL) and extracted with diethyl ether (1×). The aqueous layer was then acidified with concentrated HCl, extracted with dichloromethane (2×), and the combine dichloromethane extracts were dried over magnesium sulfate. The dichloromethane was removed under vacuum to give 0.22 g of the title compound as a solid.

¹H NMR (CDCl₃) δ 7.38(d,1H, J=5.4 Hz), 8.40 (d,1H, J=5.5 Hz), 8.60(bs,1H).

Step D: Preparation of 2,4-Dichloro-N-[[3-chloro-5-(trifluoromethyl)-2-pyridinyl]methyl]-3-pyridinecarboxamide

A solution of 2,4-dichloronicotinic acid (i.e. the product of Step C) (0.22 g) was refluxed in thionyl chloride for 1 hour followed by removal of the solvent under vacuum to live an oil. The oil was dissolved in 1 mL of dichloromethane and added to a solution of 2-aminomethyl-3-chloro-5-trifluoromethylpyridine hydrochloride (0.25 g) and triethylamine (0.20 g) in 9 mL of dichloromethane at room temperature. The reaction mixture was stirred at room temperature overnight. The reaction mixture was then filtered through silica gel, eluting with 100% methylene chloride. Removal of the solvent under vacuum provided the title compound, a compound of the present invention, as a solid, m.p. 122-124° C.

### EXAMPLE 3

### Preparation of 2,4-Dichloro-N-[1-[3-chloro-5-(trifluoromethyl)-2-pyridinyl]ethyl]-3-pyridinecarboxamide

Step A: Preparation of 3-Chloro-α-methyl-5-(trifluoromethyl)-2-pyridinemethanamine

N-(Diphenylmethylene)glycine ethyl ester (2.25 g) was added to a suspension of sodium hydride (0.74 g of 60% oil dispersion) in 20 mL of dry N,N-dimethylformamide at room temperature, resulting in vigorous gas evolution. After stirring at room temperature for five minutes, 2 g of 2,3-dichloro-5-trifluoromethylpyridine was added, followed by stirring at room temperature for 1 hour. Then 0.80 mL of methyl iodide was added followed by stirring at room temperature overnight. The reaction mixture was poured onto ice water, extracted with diethyl ether (2×), and distilled under vacuum to remove the solvent to give an oil. The oil was then refluxed in 6 N HCl overnight. The reaction mixture was cooled to room temperature, made basic with solid sodium carbonate and extracted with diethyl ether (2×). The combined organic extracts were dried over magnesium sulfate and distilled under vacuum to give 1.5 g of the title compound as an oil.

¹H NMR (CDCl₃) δ 1.4(d,3H, J=6.6 Hz), 4.6(bs,1H), 7.88(m,1H), 8.75(bs,1H).

Step B: Preparation of 2,4-Dichloro-N-[1-[3-chloro-5-(trifluoromethyl)-2-pyridinyl]ethyl]-3-pyridinecarboxamide

2,4-Dichloronicotinoyl chloride (0.40 g) (i.e. the product of Example 1, Step C) was added to a solution of 3-chloro-α-methyl-5-(trifluoromethyl)-2-pyridinemethanamine (i.e. the product of Step A) (0.66 g) and triethylamine (0.70 g) in 30 mL of dichloromethane at room temperature followed by stirring overnight. The reaction mixture was distilled under vacuum to remove the solvent, giving an oil that was filtered through silica gel using 100% dichloromethane as the eluent. The solvent was then removed under vacuum to give the title compound, a compound of the invention, as a red oil. ¹H NMR (CDCl₃; 300 MHz) δ 1.62 (d, 3H,J is 6.7 Hz), 5.48 (m,1H), 7.35(d,1H,J is 5.2 Hz), 7.40(d,1H,J is 6.9), 7.99(d,1H,J is 1.8 Hz), 8.34(d,1H,J is 5.2), 8.70(s,1H).

### EXAMPLE 4

### Preparation of (+)-2,4-Dichloro-N-[1-[3-chloro-5-(trifluoromethyl)-2-pyridinyl]ethyl]-3-pyridinecarboxamide

Step A: Resolution of 3-Chloro-α-methyl-5-(trifluoromethyl)-2-pyridinemethanamine

(−)-Menthyl chloroformate (0.92 g) was added to a solution of 3-chloro-α-methyl-5-(trifluoromethyl)-2-pyridinemethanamine (i.e. the product of Example 3, Step A) (1 g) and triethylamine (1.2 mL) in 25 mL of tetrahydrofuran at room temperature followed by stirring at room temperature for 30 minutes. The solvent was then removed under vacuum to give an oil comprising two menthylcarbamate diastereomers that were separated via column chromatography (5% diethyl ether in hexanes as eluent) to give 0.20 g of the more polar diastereomer as an oil. This oil was then refluxed in 5 mL of trifluoroacetic acid for 4 hours to cleave the menthylcarbamate. The reaction mixture was allowed to cool to room temperature and diluted with water (30 mL), made basic with solid sodium carbonate and extracted with methylene chloride. The organic extracts were dried over magnesium sulfate and concentrated to give 60 mg of the enantiomerically-enriched amine intermediate as an oil.

¹HNMR (CDCl₃) δ 1.41(d,3H, J is 6.7 Hz), 1.9(bs,2H), 4.60(m,1H), 7.88(m,1H), 8.74(s,1H).

Step B: Preparation of (+)-2,4-Dichloro-N-[1-[3-chloro-5-(trifluoromethyl)-2-pyridinyl]ethyl]-3-pyridinecarboxamide

2,4-Dichloronicotinoyl chloride (i.e. the product of Example 1, Step C) (0.56 g) was added to a solution of the enantiomerically-enriched amine from Step A (60 mg) and triethylamine (54 mg) in 10 mL of dichloromethane at room temperature followed by stirring overnight. Chromatography on silica gel (eluted with 100% dichloromethane) gave the title compound, a compound of the present invention, as a solid, m.p. 110-111° C. Polarimetric measurements of a solution of approximately 2 mg of the title compound in 1 mL of CDCl₃ rotates plane polarized light in the (+) or dextro direction.

The enantiomer of (−)-2,4-Dichloro-N-[-1-[3-chloro-5-(trifluoromethyl)-2-pyridinyl]ethyl]-3-pyridinecarboxamide was prepared in analogous fashion using 3-chloro-α-methyl-5-(trifluoromethyl)-2-pyridinemethanamine that was enriched in the opposite enantiomer from that obtained in Example 4, Step A.

Examples of compounds of Formula I suitable for use in component (a) of the compositions of this invention include the following compounds of Tables 1-3. The following abbreviations are used in the Tables which follow: Me is methyl, Et is ethyl, Ph is phenyl, OMe is methoxy, OEt is ethoxy, CN is cyano, NO₂ is nitro. The substituent Q is equivalent to R⁵ substituents that have been located in the position indicated. The substituents T, U and V are equivalent to independent R⁶ substituents that have been located in the positions indicated.

TABLE 1

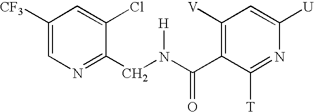

| T | U | V |
|---|---|---|
| Me | Me | Me |
| Me | Me | F |
| Me | Me | Cl |
| Me | Me | Br |
| Me | Me | CF₃ |
| Me | Me | NO₂ |
| Me | Me | OMe |
| F | Me | Me |
| F | Me | F |
| F | Me | Cl |
| F | Me | Br |
| F | Me | CF₃ |
| F | Me | NO₂ |
| F | Me | OMe |
| Cl | Me | Me |
| Cl | Me | F |
| Cl | Me | Cl |
| Cl | Me | Br |
| Cl | Me | CF₃ |
| Cl | Me | NO₂ |
| Cl | Me | OMe |
| Me | F | Me |
| Me | F | F |
| Me | F | Cl |
| Me | F | Br |
| Me | F | CF₃ |
| Me | F | NO₂ |
| Me | F | OMe |
| F | F | Me |
| F | F | F |
| F | F | Cl |
| F | F | Br |
| F | F | CF₃ |
| F | F | NO₂ |
| F | F | OMe |
| Cl | F | Me |
| Cl | F | F |
| Cl | F | Cl |
| Cl | F | Br |
| Cl | F | CF₃ |
| Cl | F | NO₂ |
| Cl | F | OMe |
| Me | Cl | Me |
| Me | Cl | F |
| Me | Cl | Cl |
| Me | Cl | Br |
| Me | Cl | CF₃ |
| Me | Cl | NO₂ |
| Me | Cl | OMe |
| F | Cl | Me |
| F | Cl | F |
| F | Cl | Cl |
| F | Cl | Br |
| F | Cl | CF₃ |
| F | Cl | NO₂ |
| F | Cl | OMe |
| Cl | Cl | Me |
| Cl | Cl | F |
| Cl | Cl | Cl |
| Cl | Cl | Br |
| Cl | Cl | CF₃ |
| Cl | Cl | NO₂ |
| Cl | Cl | OMe |
| Me | Br | Me |
| Me | Br | F |
| Me | Br | Cl |
| Me | Br | Br |
| Me | Br | CF₃ |
| Me | Br | NO₂ |
| Me | Br | OMe |
| F | Br | Me |
| F | Br | F |
| F | Br | Cl |
| F | Br | Br |
| F | Br | CF₃ |
| F | Br | NO₂ |
| F | Br | OMe |
| Cl | Br | Me |
| Cl | Br | F |
| Cl | Br | Cl |
| Cl | Br | Br |
| Cl | Br | CF₃ |
| Cl | Br | NO₂ |
| Cl | Br | OMe |
| Me | CF₃ | Me |
| Me | CF₃ | F |
| Me | CF₃ | Cl |
| Me | CF₃ | Br |
| Me | CF₃ | CF₃ |
| Me | CF₃ | NO₂ |
| Me | CF₃ | OMe |
| F | CF₃ | Me |
| F | CF₃ | F |
| F | CF₃ | Cl |
| F | CF₃ | Br |
| F | CF₃ | CF₃ |
| F | CF₃ | NO₂ |
| F | CF₃ | OMe |
| OMe | Me | Me |
| OMe | Me | F |
| OMe | Me | Cl |
| OMe | Me | Br |
| OMe | Me | CF₃ |
| OMe | Me | NO₂ |
| OMe | Me | OMe |
| OMe | F | Me |
| OMe | F | F |
| OMe | F | Cl |
| OMe | F | Br |
| OMe | F | CF₃ |
| OMe | F | NO₂ |
| OMe | F | OMe |
| OMe | Cl | Me |
| OMe | Cl | F |
| OMe | Cl | Cl |
| OMe | Cl | Br |
| OMe | Cl | CF₃ |
| OMe | Cl | NO₂ |
| OMe | Cl | OMe |
| OMe | H | Me |
| OMe | H | F |
| OMe | H | Cl |
| OMe | H | OMe |
| OMe | OMe | CF₃ |
| OMe | OMe | NO₂ |
| OMe | OMe | OMe |
| OMe | Br | Me |
| OMe | Br | F |
| OMe | Br | Cl |
| OMe | Br | Br |
| OMe | Br | CF₃ |
| OMe | Br | NO₂ |
| OMe | Br | OMe |
| OMe | CF₃ | Me |
| OMe | CF₃ | F |
| OMe | CF₃ | Cl |
| OMe | CF₃ | Br |
| OMe | CF₃ | CF₃ |
| OMe | CF₃ | NO₂ |
| OMe | CF₃ | OMe |
| OMe | NO₂ | Me |
| OMe | NO₂ | F |
| OMe | NO₂ | Cl |
| OMe | NO₂ | Br |
| OMe | NO₂ | CF₃ |
| OMe | NO₂ | NO₂ |
| OMe | NO₂ | OMe |
| OMe | H | Br |
| OMe | H | CF₃ |
| OMe | H | NO₂ |
| OMe | OMe | Me |
| OMe | OMe | F |
| OMe | OMe | Cl |
| OMe | OMe | Br |
| F | H | Me |
| F | H | F |
| F | H | Cl |
| F | H | Br |
| F | H | CF₃ |
| F | H | NO₂ |
| F | H | OMe |
| Cl | H | Me |
| Cl | H | F |
| Cl | H | Cl |
| Cl | H | Br |
| Cl | H | CF₃ |
| Cl | H | NO₂ |
| Cl | H | OMe |
| CF₃ | H | Me |
| CF₃ | H | F |
| CF₃ | H | Cl |
| CF₃ | H | Br |
| CF₃ | H | CF₃ |
| CF₃ | H | NO₂ |
| CF₃ | H | OMe |
| NO₂ | H | Me |
| NO₂ | H | F |
| NO₂ | H | Cl |
| NO₂ | H | Br |
| NO₂ | H | CF₃ |
| NO₂ | H | NO₂ |
| NO₂ | H | OMe |
| Cl | OMe | Me |
| Cl | OMe | F |
| Cl | OMe | Cl |
| Cl | OMe | Br |
| Cl | OMe | CF₃ |
| Cl | OMe | NO₂ |
| Cl | OMe | OMe |
| Me | H | Me |
| Me | H | F |
| Me | H | Cl |
| Me | H | Br |
| Me | H | CF₃ |
| Me | H | NO₂ |
| Me | H | OMe |
| Cl | NO₂ | Me |
| Cl | NO₂ | F |
| Cl | NO₂ | Cl |
| Cl | NO₂ | Br |
| Cl | NO₂ | CF₃ |
| Cl | NO₂ | NO₂ |
| Cl | NO₂ | OMe |
| CF₃ | OMe | Me |
| CF₃ | OMe | F |
| CF₃ | OMe | Cl |
| CF₃ | OMe | Br |
| CF₃ | OMe | CF₃ |
| F | OMe | Me |
| F | OMe | F |
| F | OMe | Cl |
| F | OMe | Br |
| F | OMe | CF₃ |
| F | OMe | NO₂ |
| F | OMe | OMe |
| CF₃ | OMe | NO₂ |
| CF₃ | OMe | OMe |
| Br | OMe | NO₂ |
| Br | OMe | OMe |
| NO₂ | NO₂ | Me |
| NO₂ | NO₂ | F |
| NO₂ | NO₂ | Cl |
| NO₂ | NO₂ | Br |
| NO₂ | NO₂ | CF₃ |
| NO₂ | NO₂ | NO₂ |
| NO₂ | NO₂ | OMe |
| Br | OMe | Me |
| Br | OMe | F |
| Br | OMe | Cl |
| Br | OMe | Br |
| Br | OMe | CF₃ |
| Me | NO₂ | Me |
| Me | NO₂ | F |
| Me | NO₂ | Cl |
| Me | NO₂ | Br |
| Me | NO₂ | CF₃ |
| Me | NO₂ | NO₂ |
| Me | NO₂ | OMe |
| F | NO₂ | Me |
| F | NO₂ | F |
| F | NO₂ | Cl |
| F | NO₂ | Br |
| F | NO₂ | CF₃ |
| F | NO₂ | NO₂ |
| F | NO₂ | OMe |
| Br | H | Me |
| Br | H | F |
| Br | H | Cl |
| Br | H | Br |
| Br | H | CF₃ |
| Br | H | NO₂ |
| Br | H | OMe |
| Me | OMe | Me |
| Me | OMe | F |
| Me | OMe | Cl |
| Me | OMe | Br |
| Me | OMe | CF₃ |
| Me | OMe | NO₂ |
| Me | OMe | OMe |
| Br | NO₂ | Me |
| Br | NO₂ | F |
| Br | NO₂ | Cl |
| Br | NO₂ | Br |
| Br | NO₂ | CF₃ |
| Br | NO₂ | NO₂ |
| Br | NO₂ | OMe |
| CF₃ | NO₂ | Me |
| CF₃ | NO₂ | F |
| CF₃ | NO₂ | Cl |
| CF₃ | NO₂ | Br |
| CF₃ | NO₂ | CF₃ |
| CF₃ | NO₂ | NO₂ |
| CF₃ | NO₂ | OMe |
| Cl | CF₃ | Me |
| Cl | CF₃ | F |
| Cl | CF₃ | Cl |
| Cl | CF₃ | Br |
| Cl | CF₃ | CF₃ |
| Cl | CF₃ | NO₂ |
| Cl | CF₃ | OMe |
| NO₂ | OMe | Me |
| NO₂ | OMe | F |
| NO₂ | OMe | Cl |
| NO₂ | OMe | Br |
| NO₂ | OMe | CF₃ |
| NO₂ | OMe | NO₂ |
| NO₂ | OMe | OMe |
| NO₂ | CF₃ | Me |
| NO₂ | CF₃ | F |
| NO₂ | CF₃ | Cl |
| NO₂ | CF₃ | Br |
| NO₂ | CF₃ | CF₃ |
| NO₂ | CF₃ | NO₂ |
| NO₂ | CF₃ | OMe |
| Br | Me | Me |
| Br | Me | F |
| Br | Me | Cl |
| Br | Me | Br |
| Br | Me | CF₃ |
| Br | Me | NO₂ |
| Br | Me | OMe |
| CF₃ | Me | Me |
| CF₃ | Me | F |
| CF₃ | Me | Cl |
| CF₃ | Me | Br |
| CF₃ | Me | CF₃ |
| CF₃ | Me | NO₂ |
| CF₃ | Me | OMe |
| NO₂ | Me | Me |
| NO₂ | Me | F |
| NO₂ | Me | Cl |
| NO₂ | Me | Br |
| NO₂ | Me | CF₃ |
| NO₂ | Me | NO₂ |
| NO₂ | Me | OMe |
| Br | F | Me |
| Br | F | F |
| Br | F | Cl |
| Br | F | Br |
| Br | F | CF₃ |
| Br | F | NO₂ |
| Br | F | OMe |
| CF₃ | F | Me |
| CF₃ | F | F |
| CF₃ | F | Cl |
| CF₃ | F | Br |
| CF₃ | F | CF₃ |
| CF₃ | F | NO₂ |
| CF₃ | F | OMe |
| NO₂ | F | Me |
| NO₂ | F | F |
| NO₂ | F | Cl |
| NO₂ | F | Br |
| NO₂ | F | CF₃ |
| NO₂ | F | NO₂ |
| NO₂ | F | OMe |
| Br | Cl | Me |
| Br | Cl | F |
| Br | Cl | Cl |
| Br | Cl | Br |
| Br | Cl | CF₃ |
| Br | Cl | NO₂ |
| Br | Cl | OMe |
| CF₃ | Cl | Me |
| CF₃ | Cl | F |
| CF₃ | Cl | Cl |
| CF₃ | Cl | Br |
| CF₃ | Cl | CF₃ |
| CF₃ | Cl | NO₂ |
| CF₃ | Cl | OMe |
| NO₂ | Cl | Me |
| NO₂ | Cl | F |
| NO₂ | Cl | Cl |
| NO₂ | Cl | Br |
| NO₂ | Cl | CF₃ |
| NO₂ | Cl | NO₂ |
| NO₂ | Cl | OMe |
| Br | Br | Me |
| Br | Br | F |
| Br | Br | Cl |
| Br | Br | Br |
| Br | Br | CF₃ |
| Br | Br | NO₂ |
| Br | Br | OMe |
| CF₃ | Br | Me |
| CF₃ | Br | F |
| CF₃ | Br | Cl |
| CF₃ | Br | Br |
| CF₃ | Br | CF₃ |
| CF₃ | Br | NO₂ |
| CF₃ | Br | OMe |
| NO₂ | Br | Me |
| NO₂ | Br | F |
| NO₂ | Br | Cl |
| NO₂ | Br | Br |
| NO₂ | Br | CF₃ |
| NO₂ | Br | NO₂ |
| NO₂ | Br | OMe |
| Br | CF₃ | Me |
| Br | CF₃ | F |
| Br | CF₃ | Cl |
| Br | CF₃ | Br |
| Br | CF₃ | CF₃ |
| Br | CF₃ | NO₂ |
| Br | CF₃ | OMe |
| CF₃ | CF₃ | Me |
| CF₃ | CF₃ | F |
| CF₃ | CF₃ | Cl |
| CF₃ | CF₃ | Br |
| CF₃ | CF₃ | CF₃ |
| CF₃ | CF₃ | NO₂ |
| CF₃ | CF₃ | OMe |

TABLE 2

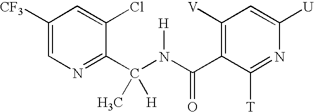

| T | U | V |
|---|---|---|
| Me | Me | Me |
| Me | Me | F |
| Me | Me | Cl |
| Me | Me | Br |
| Me | Me | CF₃ |
| Me | Me | NO₂ |
| Me | Me | OMe |
| F | Me | Me |
| F | Me | F |
| F | Me | Cl |
| F | Me | Br |
| F | Me | CF₃ |
| F | Me | NO₂ |
| F | Me | OMe |
| Cl | Me | Me |
| Cl | Me | F |
| Cl | Me | Cl |
| Cl | Me | Br |
| Cl | Me | CF₃ |
| Cl | Me | NO₂ |
| Cl | Me | OMe |
| Me | F | Me |
| Me | F | F |
| Me | F | Cl |
| Me | F | Br |
| Me | F | CF₃ |
| Me | F | NO₂ |
| Me | F | OMe |
| F | F | Me |
| F | F | F |
| F | F | Cl |
| F | F | Br |
| F | F | CF₃ |
| F | F | NO₂ |
| F | F | OMe |
| Cl | F | Me |
| Cl | F | F |
| Cl | F | Cl |
| Cl | F | Br |
| Cl | F | CF₃ |
| Cl | F | NO₂ |
| Cl | F | OMe |
| Me | Cl | Me |
| Me | Cl | F |
| Me | Cl | Cl |
| Me | Cl | Br |
| Me | Cl | CF₃ |
| Me | Cl | NO₂ |
| Me | Cl | OMe |
| F | Cl | Me |
| F | Cl | F |
| F | Cl | Cl |
| F | Cl | Br |
| F | Cl | CF₃ |
| F | Cl | NO₂ |
| F | Cl | OMe |
| Cl | Cl | Me |
| Cl | Cl | F |
| Cl | Cl | Cl |
| Cl | Cl | Br |
| Cl | Cl | CF₃ |
| Cl | Cl | NO₂ |
| Cl | Cl | OMe |
| Me | Br | Me |
| Me | Br | F |
| Me | Br | Cl |
| Me | Br | Br |
| Me | Br | CF₃ |
| Me | Br | NO₂ |
| Me | Br | OMe |
| F | Br | Me |
| F | Br | F |
| F | Br | Cl |
| F | Br | Br |
| F | Br | CF₃ |
| F | Br | NO₂ |
| F | Br | OMe |
| Cl | Br | Me |
| Cl | Br | F |
| Cl | Br | Cl |
| Cl | Br | Br |
| Cl | Br | CF₃ |
| Cl | Br | NO₂ |
| Cl | Br | OMe |
| Me | CF₃ | Me |
| Me | CF₃ | F |
| Me | CF₃ | Cl |
| Me | CF₃ | Br |
| Me | CF₃ | CF₃ |
| Me | CF₃ | NO₂ |
| Me | CF₃ | OMe |
| F | CF₃ | Me |
| F | CF₃ | F |
| F | CF₃ | Cl |
| F | CF₃ | Br |
| F | CF₃ | CF₃ |
| F | CF₃ | NO₂ |
| F | CF₃ | OMe |
| OMe | Me | Me |
| OMe | Me | F |
| OMe | Me | Cl |
| OMe | Me | Br |
| OMe | Me | CF₃ |
| OMe | Me | NO₂ |
| OMe | Me | OMe |
| OMe | F | Me |
| OMe | F | F |
| OMe | F | Cl |
| OMe | F | Br |
| OMe | F | CF₃ |
| OMe | F | NO₂ |
| OMe | F | OMe |
| OMe | Cl | Me |
| OMe | Cl | F |
| OMe | Cl | Cl |
| OMe | Cl | Br |
| OMe | Cl | CF₃ |
| OMe | Cl | NO₂ |
| OMe | Cl | OMe |
| OMe | H | Me |
| OMe | H | F |
| OMe | H | Cl |
| OMe | H | OMe |
| OMe | OMe | CF₃ |
| OMe | OMe | NO₂ |
| OMe | OMe | OMe |
| OMe | Br | Me |
| OMe | Br | F |
| OMe | Br | Cl |
| OMe | Br | Br |
| OMe | Br | CF₃ |
| OMe | Br | NO₂ |
| OMe | Br | OMe |
| OMe | CF₃ | Me |
| OMe | CF₃ | F |
| OMe | CF₃ | Cl |
| OMe | CF₃ | Br |
| OMe | CF₃ | CF₃ |
| OMe | CF₃ | NO₂ |
| OMe | CF₃ | OMe |
| OMe | NO₂ | Me |
| OMe | NO₂ | F |
| OMe | NO₂ | Cl |
| OMe | NO₂ | Br |
| OMe | NO₂ | CF₃ |
| OMe | NO₂ | NO₂ |
| OMe | NO₂ | OMe |
| OMe | H | Br |
| OMe | H | CF₃ |
| OMe | H | NO₂ |
| OMe | OMe | Me |
| OMe | OMe | F |
| OMe | OMe | Cl |
| OMe | OMe | Br |
| F | H | Me |
| F | H | F |
| F | H | Cl |
| F | H | Br |
| F | H | CF₃ |
| F | H | NO₂ |
| F | H | OMe |
| Cl | H | Me |
| Cl | H | F |
| Cl | H | Cl |
| Cl | H | Br |
| Cl | H | CF₃ |
| Cl | H | NO₂ |
| Cl | H | OMe |
| CF₃ | H | Me |
| CF₃ | H | F |
| CF₃ | H | Cl |
| CF₃ | H | Br |
| CF₃ | H | CF₃ |
| CF₃ | H | NO₂ |
| CF₃ | H | OMe |
| NO₂ | H | Me |
| NO₂ | H | F |
| NO₂ | H | Cl |
| NO₂ | H | Br |
| NO₂ | H | CF₃ |
| NO₂ | H | NO₂ |
| NO₂ | H | OMe |
| Cl | OMe | Me |
| Cl | OMe | F |
| Cl | OMe | Cl |
| Cl | OMe | Br |
| Cl | OMe | CF₃ |
| Cl | OMe | NO₂ |
| Cl | OMe | OMe |
| Me | H | Me |
| Me | H | F |
| Me | H | Cl |
| Me | H | Br |
| Me | H | CF₃ |
| Me | H | NO₂ |
| Me | H | OMe |
| Cl | NO₂ | Me |
| Cl | NO₂ | F |
| Cl | NO₂ | Cl |
| Cl | NO₂ | Br |
| Cl | NO₂ | CF₃ |
| Cl | NO₂ | NO₂ |
| Cl | NO₂ | OMe |
| CF₃ | OMe | Me |
| CF₃ | OMe | F |
| CF₃ | OMe | Cl |
| CF₃ | OMe | Br |
| CF₃ | OMe | CF₃ |
| F | OMe | Me |
| F | OMe | F |
| F | OMe | Cl |
| F | OMe | Br |
| F | OMe | CF₃ |
| F | OMe | NO₂ |
| F | OMe | OMe |
| CF₃ | OMe | NO₂ |
| CF₃ | OMe | OMe |
| Br | OMe | NO₂ |
| Br | OMe | OMe |
| NO₂ | NO₂ | Me |
| NO₂ | NO₂ | F |
| NO₂ | NO₂ | Cl |
| NO₂ | NO₂ | Br |
| NO₂ | NO₂ | CF₃ |
| NO₂ | NO₂ | NO₂ |
| NO₂ | NO₂ | OMe |
| Br | OMe | Me |
| Br | OMe | F |
| Br | OMe | Cl |
| Br | OMe | Br |
| Br | OMe | CF₃ |
| Me | NO₂ | Me |
| Me | NO₂ | F |
| Me | NO₂ | Cl |
| Me | NO₂ | Br |
| Me | NO₂ | CF₃ |
| Me | NO₂ | NO₂ |
| Me | NO₂ | OMe |
| F | NO₂ | Me |
| F | NO₂ | F |
| F | NO₂ | Cl |
| F | NO₂ | Br |
| F | NO₂ | CF₃ |
| F | NO₂ | NO₂ |
| F | NO₂ | OMe |
| Br | H | Me |
| Br | H | F |
| Br | H | Cl |
| Br | H | Br |
| Br | H | CF₃ |
| Br | H | NO₂ |
| Br | H | OMe |
| Me | OMe | Me |
| Me | OMe | F |
| Me | OMe | Cl |
| Me | OMe | Br |
| Me | OMe | CF₃ |
| Me | OMe | NO₂ |
| OMe | OMe | OMe |
| Br | NO₂ | Me |
| Br | NO₂ | F |
| Br | NO₂ | Cl |
| Br | NO₂ | Br |
| Br | NO₂ | CF₃ |
| Br | NO₂ | NO₂ |
| Br | NO₂ | OMe |
| CF₃ | NO₂ | Me |
| CF₃ | NO₂ | F |
| CF₃ | NO₂ | Cl |
| CF₃ | NO₂ | Br |
| CF₃ | NO₂ | CF₃ |
| CF₃ | NO₂ | NO₂ |
| CF₃ | NO₂ | OMe |
| Cl | CF₃ | Me |
| Cl | CF₃ | F |
| Cl | CF₃ | Cl |
| Cl | CF₃ | Br |
| Cl | CF₃ | CF₃ |
| Cl | CF₃ | NO₂ |
| Cl | CF₃ | OMe |
| NO₂ | OMe | Me |
| NO₂ | OMe | F |
| NO₂ | OMe | Cl |
| NO₂ | OMe | Br |
| NO₂ | OMe | CF₃ |
| NO₂ | OMe | NO₂ |
| NO₂ | OMe | OMe |
| NO₂ | CF₃ | Me |
| NO₂ | CF₃ | F |
| NO₂ | CF₃ | Cl |
| NO₂ | CF₃ | Br |
| NO₂ | CF₃ | CF₃ |
| NO₂ | CF₃ | NO₂ |
| NO₂ | CF₃ | OMe |
| Br | Me | Me |
| Br | Me | F |
| Br | Me | Cl |
| Br | Me | Br |
| Br | Me | CF₃ |
| Br | Me | NO₂ |
| Br | Me | OMe |
| CF₃ | Me | Me |
| CF₃ | Me | F |
| CF₃ | Me | Cl |
| CF₃ | Me | Br |
| CF₃ | Me | CF₃ |
| CF₃ | Me | NO₂ |
| CF₃ | Me | OMe |
| NO₂ | Me | Me |
| NO₂ | Me | F |
| NO₂ | Me | Cl |
| NO₂ | Me | Br |
| NO₂ | Me | CF₃ |
| NO₂ | Me | NO₂ |
| NO₂ | Me | OMe |
| Br | F | Me |
| Br | F | F |
| Br | F | Cl |
| Br | F | Br |
| Br | F | CF₃ |
| Br | F | NO₂ |
| Br | F | OMe |
| CF₃ | F | Me |
| CF₃ | F | F |
| CF₃ | F | Cl |
| CF₃ | F | Br |
| CF₃ | F | CF₃ |
| CF₃ | F | NO₂ |
| CF₃ | F | OMe |
| NO₂ | F | Me |
| NO₂ | F | F |
| NO₂ | F | Cl |
| NO₂ | F | Br |
| NO₂ | F | CF₃ |
| NO₂ | F | NO₂ |
| NO₂ | F | OMe |
| Br | Cl | Me |
| Br | Cl | F |
| Br | Cl | Cl |
| Br | Cl | Br |
| Br | Cl | CF₃ |
| Br | Cl | NO₂ |
| Br | Cl | OMe |
| CF₃ | Cl | Me |
| CF₃ | Cl | F |
| CF₃ | Cl | Cl |
| CF₃ | Cl | Br |
| CF₃ | Cl | CF₃ |
| CF₃ | Cl | NO₂ |
| CF₃ | Cl | OMe |
| NO₂ | Cl | Me |
| NO₂ | Cl | F |
| NO₂ | Cl | Cl |
| NO₂ | Cl | Br |
| NO₂ | Cl | CF₃ |
| NO₂ | Cl | NO₂ |
| NO₂ | Cl | OMe |
| Br | Br | Me |
| Br | Br | F |
| Br | Br | Cl |
| Br | Br | Br |
| Br | Br | CF₃ |
| Br | Br | NO₂ |
| Br | Br | OMe |
| CF₃ | Br | Me |
| CF₃ | Br | F |
| CF₃ | Br | Cl |
| CF₃ | Br | Br |
| CF₃ | Br | CF₃ |
| CF₃ | Br | NO₂ |
| CF₃ | Br | OMe |
| NO₂ | Br | Me |
| NO₂ | Br | F |
| NO₂ | Br | Cl |
| NO₂ | Br | Br |
| NO₂ | Br | CF₃ |
| NO₂ | Br | NO₂ |
| NO₂ | Br | OMe |
| Br | CF₃ | Me |
| Br | CF₃ | F |
| Br | CF₃ | Cl |
| Br | CF₃ | Br |
| Br | CF₃ | CF₃ |
| Br | CF₃ | NO₂ |
| Br | CF₃ | OMe |
| CF₃ | CF₃ | Me |
| CF₃ | CF₃ | F |
| CF₃ | CF₃ | Cl |
| CF₃ | CF₃ | Br |
| CF₃ | CF₃ | CF₃ |
| CF₃ | CF₃ | NO₂ |
| CF₃ | CF₃ | OMe |

TABLE 3

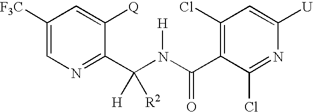

| Q | R² | U |
|---|---|---|
| I | H | H |
| OCHF₂ | H | H |
| OCH₂F | H | H |
| OCF₂Cl | H | H |
| OCH₂CF₃ | H | H |
| Et | H | H |
| CN | H | H |
| NH₂ | H | H |
| NHCOMe | H | H |
| NHCOCF₃ | H | H |
| SCF₃ | H | H |
| SCHF₂ | H | H |
| SCH₂F | H | H |
| Ph | H | H |
| SiMe₃ | H | H |
| I | Me | H |
| OCHF₂ | Me | H |
| OCH₂F | Me | H |
| OCF₂Cl | Me | H |
| OCH₂CF₃ | Me | H |
| Et | Me | H |
| CN | Me | H |
| NH₂ | Me | H |
| NHCOMe | Me | H |
| NHCOCF₃ | Me | H |
| SCF₃ | Me | H |
| SCHF₂ | Me | H |
| SCH₂F | Me | H |
| Ph | Me | H |
| SiMe₃ | Me | H |
| I | H | Me |
| OCHF₂ | H | Me |
| OCH₂F | H | Me |
| OCF₂Cl | H | Me |
| OCH₂CF₃ | H | Me |
| Et | H | Me |
| CN | H | Me |
| NH₂ | H | Me |
| NHCOMe | H | Me |
| NHCOCF₃ | H | Me |
| SCF₃ | H | Me |
| SCHF₂ | H | Me |
| SCH₂F | H | Me |
| Ph | H | Me |
| SiMe₃ | H | Me |
| I | Me | Me |
| OCHF₂ | Me | Me |
| OCH₂F | Me | Me |
| OCF₂Cl | Me | Me |
| OCH₂CF₃ | Me | Me |
| Et | Me | Me |
| CN | Me | Me |
| NH₂ | Me | Me |
| NHCOMe | Me | Me |
| NHCOCF₃ | Me | Me |
| SCF₃ | Me | Me |
| SCHF₂ | Me | Me |
| SCH₂F | Me | Me |
| Ph | Me | Me |
| SiMe₃ | Me | Me |

The fungicides of component (b) of the compositions of the invention are selected from the group consisting of
(b1) alkylenebis(dithiocarbamate) fungicides;
(b2) compounds acting at the bc₁ complex of the fungal mitochondrial respiratory electron transfer site;
(b3) cymoxanil;
(b4) compounds acting at the demethylase enzyme of the sterol biosynthesis pathway;
(b5) morpholine and piperidine compounds that act on the sterol biosynthesis pathway;
(b6) phenylamide fungicides;
(b7) pyrimidinone fungicides;
(b8) phthalimides; and
(b9) fosetyl-aluminum.

The weight ratios of component (b) to component (a) typically is from 100:1 to 1:100, preferably is from 30:1 to 1:30, and more preferably is from 10:1 to 1:10. Of note are compositions wherein the weight ratio of component (b) to component (a) is from 10:1 to 1:1. Included are compositions wherein the weight ratio of component (b) to component (a) is from 9:1 to 4.5:1.

The bc₁ Complex Fungicides (Component (2)

Strobilurin fungicides such as azoxystrobin, kresoxim-methyl, metominostrobin/fenominostrobin (SSF-126), picoxystrobin, pyraclostrobin and trifloxystrobin are known to have a fungicidal mode of action which inhibits the bc₁ complex in the mitochondrial respiration chain (Angew. Chem. Int. Ed., 1999, 38, 1328-1349). Methyl (E)-2-[[6-(2-cyanophenoxy)-4-pyrimidinyl]oxy]-α-(methoxyimino)benzeneacetate (also known as azoxystrobin) is described as a bc₁ complex inhibitor in Biochemical Society Transactions 1993, 22, 68S. Methyl (E)-α-(methoxyimino)-2-[(2-methylphenoxy)methyl]benzeneacetate (also known as kresoxim-methyl) is described as a bc₁ complex inhibitor in Biochemical Society Transactions 1993, 22, 64S. (E)-2-[(2,5-Dimethylphenoxy)methyl]-α-(methoxyimino)-N-methylbenzeneacetamide is described as a bc₁ complex inhibitor in Biochemistry and Cell Biology 1995, 85(3), 306-311. Other compounds that inhibit the bc, complex in the mitochondrial respiration chain include famoxadone and fenamidone.

The bc₁ complex is sometimes referred to by other names in the biochemical literature, including complex III of the electron transfer chain, and ubihydroquinone:cytochrome c oxidoreductase. It is uniquely identified by the Enzyme Commission number EC1.10.2.2. The bc₁ complex is described in, for example, J. Biol. Chem. 1989, 264, 14543-38; Methods Enzymol. 1986, 126, 253-71; and references cited therein.

The Sterol Biosynthesis Inhibitor Fungicides (Component (b4) or (b5))

The class of sterol biosynthesis inhibitors includes DMI and non-DMI compounds, that control fungi by inhibiting enzymes in the sterol biosynthesis pathway. DMI fungicides have a common site of action within the fungal sterol biosynthesis pathway; that is, an inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides fall into several classes: azoles (including triazoles and imidazoles), pyrimidines, piperazines and pyridines. The triazoles includes bromuconazole, cyproconazole, difenoconazole, diniconazole, epoxiconazole, fenbuconazole, fluquinconazole, flusilazole, flutriafol, hexaconazole, ipconazole, metconazole, penconazole, propiconazole, tebuconazole, tetraconazole, triadimefon, triadimenol, triticonazole and uniconazole. The imidazoles include clotrimazole, econazole, imazalil, isoconazole, miconazole and prochloraz. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck, et al. in Modern Selective Fungicides—Properties, Applications and Mechanisms of Action, Lyr, H., Ed.; Gustav Fischer Verlag: New York, 1995, 205-258.

The DMI fungicides have been grouped together to distinguish them from other sterol biosynthesis inhibitors, such as, the morpholine and piperidine fungicides. The morpholines and piperidines are also sterol biosynthesis inhibitors but have been shown to inhibit later steps in the sterol biosynthesis pathway. The morpholines include aldimorph, dodemorph, fenpropimorph, tridemorph and trimorphamide. The piperidines include fenpropidin. Biochemical investigations have shown that all of the above mentioned morpholine and piperidine fungicides are sterol biosynthesis inhibitor fungicides as described by K. H. Kuck, et al. in Modern Selective Fungicides—Properties, Applications and Mechanisms of Action, Lyr, H., Ed.; Gustav Fischer Verlag: New York, 1995, 185-204.

Pyrimidinone Fungicides (Component (b7))

Pyrimidinone fungicides include compounds of Formula II 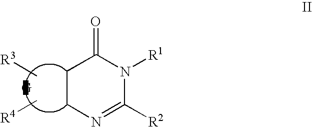
wherein
G is a fused phenyl, thiophene or pyridine ring;
R¹ is C₁-C₆ alkyl;
R² is C₁-C₆ alkyl or C₁-C₆ alkoxy;
R³ is halogen; and
R⁴ is hydrogen or halogen.

Pyrimidinone fungicides are described in International Patent Application WO94/26722, U.S. Pat. No. 6,066,638, U.S. Pat. No. 6,245,770, U.S. Pat. No. 6,262,058 and U.S. Pat. No. 6,277,858.

Of note are pyrimidinone fungicides selected from the group:
6-bromo-3-propyl-2-propyloxy-4(3H)-quinazolinone,
6,8-diiodo-3-propyl-2-propyloxy-4(3H)-quinazolinone,
6-iodo-3-propyl-2-propyloxy-4(3H)-quinazolinone,
6-chloro-2-propoxy-3-propylthieno[2,3-d]pyrimidin-4(3H)-one,
6-bromo-2-propoxy-3-propylthieno[2,3-d]pyrimidin-4(3H)-one,
7-bromo-2-propoxy-3-propylthieno[3,2-d]pyrimidin-4(3H)-one,
6-bromo-2-propoxy-3-propylpyrido-[2,3-d]pyrimidin-4(3H)-one,
6,7-dibromo-2-propoxy-3-propylthieno[3,2-d]pyrimidin-4(3H)-one, and

3-(cyclopropylmethyl)-6-iodo-2-(propylthio)pyrido[2,3-d]pyrimidin-4(3H)-one.

TABLE 7

| | Examples of component (b) |
|---|---|
| (b1) | Alkylenebis(dithiocarbamate)s such as mancozeb, |
| | maneb, propineb and zineb |
| (b3) | Cymoxanil |
| (b6) | Phenylamides such as metalaxyl, benalaxyl and oxadixyl |
| (b8) | Phthalimids such as folpet or captan |
| (b9) | Fosetyl-aluminum |

Other fungicides which can be included in compositions of this invention in combination with a Formula I compound or as an additional component combined with component (a) and component (b) are acibenzolar, benalaxyl, benomyl, blasticidin-S, Bordeaux mixture (tribasic copper sulfite), carpropamid, captafol captan, carbendazim, chloroneb, chlorothalonil, copper oxychloride, copper salts such as copper sulfate and copper hydroxide, cyazofamid, cymoxanil, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, dimethomorph, diniconazole-M, dodemorph, dodine, edifenphos, fencaramid (SZX072), fenpiclonil, fentin acetate, fentin hydroxide, fluazinam, fludioxonil, flumetover (RPA 403397), flutolanil, folpet, fosetyl-aluminum, furalaxyl, furametapyr (S-82658), iprobenfos, iprodione, isoprothiolane, iprovalicarb, kasugamycin, mancozeb, maneb, mefenoxam, mepronil, metalaxyl, metiram-zinc, myclobutanil, neo-asozin (ferric methanearsonate), oxadixyl, pencycuron, prochloraz, procymidone, propamocarb, propineb, pyrifenox, pyrimethanil, pyroquilon, quinoxyfen, spiroxamine, sulfur, thifluzamide, thiophanate-methyl, thiram, triadimefon, tricyclazole, validamycin, vinclozolin, zineb and zoxamid.

Descriptions of the commercially available compounds listed above may be found in The Pesticide Manual, Twelfth Edition, C. D. S. Tomlin, ed., British Crop Protection Council, 2000.

Of note are combinations of Formula I with fungicides of a different biochemical mode of action (e.g. mitochondrial respiration inhibition, inhibition of protein synthesis by interference of the synthesis of ribosomal RNA or inhibition of beta-tubulin synthesis) that can be particularly advantageous for resistance management. Examples include combinations of compounds of Formula I (e.g. Compound 1) with strobilurins such as azoxystrobin, kresoxim-methyl, pyraclostrobin and trifloxystrobin; carbendazim, mitochondrial respiration inhibitors such as famoxadone and fenamidone; benomyl, cymoxanil; dimethomorph; folpet; fosetyl-aluminum; metalaxyl; mancozeb and maneb. These combinations can be particularly advantageous for resistance management, especially where the fungicides of the combination control the same or similar diseases.

Of note are combinations of Formula I with fungicides for controlling grape diseases (e.g. Plasmopara viticola, Botrytis cinerea and Uncinula necatur) including alkylenebis(dithiocarbamate)s such as mancozeb, maneb, propineb and zineb, phthalimids such as folpet, copper salts such as copper sulfate and copper hydroxide, strobilurins such as azoxystrobin, pyraclostrobin and trifloxystrobin, mitochondrial respiration inhibitors such as famoxadone and fenamidone, phenylamides such as metalaxyl, phosphonates such as fosetyl-Al, dimethomorph, pyrimidinone fungicides such as 6-iodo-3-propyl-2-propyloxy-4(3H)-quinazolinone and 6-chloro-2-propoxy-3-propylthieno[2,3-d]pyrimidin-4(3H)-one, and other fungicides such as cymoxanil.

Of note are combinations of Formula I with fungicides for controlling potato diseases (e.g. Phytophthora infestans, Alternaria solani and Rhizoctonia solani) including alkylenebis(dithiocarbamate)s such as mancozeb, maneb, propineb and zineb; copper salts such as copper sulfate and copper hydroxide; strobilurins such as pyraclostrobin and trifloxystrobin; mitochondrial respiration inhibitors such as famoxadone and fenamidone; phenylamides such as metalaxyl; carbamates such as propamocarb; phenylpyridylamines such as fluazinam and other fungicides such as chlorothalonil, cyazofamid, cymoxanil, dimethomorph, zoxamid and iprovalicarb.

Of note are compositions wherein component (b) comprises at least one compound from each of two different groups selected from (b1), (b2), (b3), (b4), (b5), (b6), (b7), (b8) and (b9). The weight ratio of the compound(s) of the first of these two component (b) groups to the compound(s) of the second of these component (b) groups typically is from 100:1 to 1:100, more typically from 30:1 to 1:30 and most typically from 10:1 to 1:10.

Of note are compositions wherein component (b) comprises at least one compound selected from (b1), for example mancozeb, and at least one compound selected from a second component (b) group, for example, from (b2), (b3), (b6), (b7), (b8) or (b9). Of particular note are such compositions wherein the overall weight ratio of component (b) to component (a) is from 30:1 to 1:30 and the weight ratio of component (b1) to component (a) is from 10:1 to 1:1. Included are compositions wherein the weight ratio of component (b1) to component (a) is from 9:1 to 4.5:1. Examples of these compositions include compositions comprising mixtures of component (a) (preferably a compound from Index Table A) with mancozeb and a compound selected from the group consisting of famoxadone, fenamidone, azoxystrobin, kresoxim-methyl, pyraclostrobin, trifloxystrobin, cymoxanil metalaxyl, benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises at least one compound selected from (b2), for example famoxadone, and at least one compound selected from a second component (b) group, for example, from (b1), (b3), (b6), (b7), (b8) or (b9). Of particular note are such compositions wherein the overall weight ratio of component (b) to component (a) is from 30:1 to 1:30 and the weight ratio of component (b2) to component (a) is from 10:1 to 1:1. Included are compositions wherein the weight ratio of component (b2) to component (a) is from 9:1 to 4.5:1. Examples of these compositions include compositions comprising mixtures of component (a) (preferably a compound from Index Table A) with famoxadone and a compound selected from the group consisting of mancozeb, maneb, propineb, zineb, cymoxanil metalaxyl benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises the compound of (b3), in other words cymoxanil and at least one compound selected from a second component (b) group, for example, from (b1), (b2), (b6), (b7), (b8) or (b9). Of particular note are such compositions wherein the overall weight ratio of component (b) to component (a) is from 30:1 to 1:30 and the weight ratio of component (b3) to component (a) is from 10:1 to 1:1. Included are compositions wherein the weight ratio of component (b3) to component (a) is from 9:1 to 4.5:1. Examples of these compositions include compositions comprising mixtures of component (a) (preferably a compound from Index Table A) with cymoxanil and a compound selected from the group consisting of famoxadone, fenamidone, azoxystrobin, kresoxim-methyl, pyraclostrobin, trifloxystrobin, mancozeb, maneb, propineb, zineb, metalaxyl, benalaxyl oxadixyl, 6-iodo-3-propyl-2-propyloxy-4(3H)-quinazolinone, 6-chloro-2-propoxy-3-propylthieno[2,3-d-]pyrimidin-4(3H)-one, folpet, captan and fosetyl-aluminum.

Also of note are compositions wherein component (b) comprises at least one compound selected from (b6), for example metalaxyl, and at least one compound selected from a second component (b) group, for example, from (b1), (b2), (b3), (b7), (b8) or (b9). Of particular note are such compositions wherein the overall weight ratio of component (b) to component (a) is from 30:1 to 1:30 and the weight ratio of component (b6) to component (a) is from 10:1 to 1:3. Included are compositions wherein the weight ratio of component (b6) to component (a) is from 9:1 to 4.5:1. Examples of these compositions include compositions comprising mixtures of component (a) (preferably a compound from Index Table A) with metalaxyl or oxadixyl and a compound selected from the group consisting of famoxadone, fenamidone, azoxystrobin, kresoxim-methyl, pyraclostrobin, trifloxystrobin, cymoxanil, mancozeb, maneb, propineb, zineb, 6-iodo-3-propyl-2-propyloxy-4(3H)-quinazolinone, 6-chloro-2-propoxy-3-propylthieno[2,3-d]pyrimidin-4(3H)-one, folpet, captan and fosetyl-aluminum.

Also of note are compositions wherein component (b) comprises at least one compound selected from (b7), for example 6-iodo-3-propyl-2-propyloxy-4(3H)-quinazolinone or 6-chloro-2-propoxy-3-propylthieno[2,3-d]pyrimidin-4(3H)-one, and at least one compound selected from a second component (b) group, for example, from (b1), (b2), (b3), (b6), (b8) or (b9). Of particular note are such compositions wherein the overall weight ratio of component (b) to component (a) is from 30:1 to 1:30 and the weight ratio of component (b7) to component (a) is from 1:1 to 1:20. Included are compositions wherein the weight ratio of component (b6) to component (a) is from 1:4.5 to 1:9. Examples of these compositions include compositions comprising mixtures of component (a) (preferably a compound from Index Table A) with 6-iodo-3-propyl-2-propyloxy-4(3H)-quinazolinone or 6-chloro-2-propoxy-3-propylthieno[2,3-d]pyrimidin-4(3H)-one and a compound selected from the group consisting of famoxadone, fenamidone, azoxystrobin, kresoxim-methyl, pyraclostrobin, trifloxystrobin, cymoxanil mancozeb, maneb, propineb, zineb, metalaxyl, benalaxyl, oxadixyl, folpet, captan and fosetyl-aluminum.

Also of note are compositions wherein component (b) comprises the compound of (b9), in other words fosetyl-aluminum, and at least one compound selected from a second component (b) group, for example, from (b1), (b2), (b3), (b6) or (b7). Of particular note are such compositions wherein the overall weight ratio of component (b) to component (a) is from 30:1 to 1:30 and the weight ratio of component (b9) to component (a) is from 10:1 to 1:1. Included are compositions wherein the weight ratio of component (b9) to component (a) is from 9:1 to 4.5:1. Examples of these compositions include compositions comprising mixtures of component (a) (preferably a compound from Index Table A) with fosetyl-aluminum and a compound selected from the group consisting of famoxadone, fenamidone, azoxystrobin, kresoxim-methyl, pyraclostrobin trifloxystrobin, mancozeb, maneb, propineb, zineb, metalaxyl, benalaxyl, oxadixyl, 6-iodo-3-propyl-2-propyloxy-4(3H)-quinazolinone, 6-chloro-2-propoxy-3-propylthieno[2,3-d]pyrimidin-4(3H)-one, folpet, captan and cymoxanil.

Of note are combinations of compounds of Formula I with fungicides giving an even broader spectrum of agricultural protection including strobilurins such as azoxystrobin, kresoxim-methyl, pyraclostrobin and trifloxystrobin; morpholines such as fenpropidine and fenpropimorph; triazoles such as bromuconazole, cyproconazole, difenoconazole, epoxyconazole, flusilazole, ipconazole, metconazole, propiconazole, tebuconazole and triticonazole; pyrimidinone fungicides, benomyl; carbendazim; chlorothalonil; dimethomorph; folpet; mancozeb; maneb; quinoxyfen; validamycin and vinclozolin.

Preferred 4. Preferred compositions comprise a compound of component (a) mixed with cymoxanil.

Preferred 5. Preferred compositions comprise a compound of component (a) mixed with a compound selected from (b1). More preferred is a composition wherein the compound of (b1) is mancozeb.

Preferred 6. Preferred compositions comprise a compound of component (a) mixed with a compound selected from (b2). More preferred is a composition wherein the compound of (b2) is famoxadone.

Of particular note are combinations of Compound 1 or Compound 21 with azoxystrobin, combinations of Compound 0.1 or Compound 21 with kresoxim-methyl, combinations of Compound 1 or Compound 21 with pyrclostrobin, combinations of Compound 1 or Compound 21 with trifloxystrobin, combinations of Compound 1 or Compound 21 with carbendazim, combinations of Compound 1 or Compound 21 with chlorothalonil, combinations of Compound 1 or Compound 21 with dimethomorph, combinations of Compound 1 or Compound 21 with folpet, combinations of Compound 1 or Compound 21 with mancozeb, combinations of Compound 1 or Compound 21 with maneb, combinations of Compound 1 or Compound 21 with quinoxyfen, combinations of Compound 1 or Compound 21 with validamycin, combinations of Compound 1 or Compound 21 with vinclozolin, Compound 1 or Compound 21 with fenpropidine, combinations of Compound 1 or Compound 21 with fenpropimorph, combinations of Compound 1 or Compound 21 with bromuconazole, combinations of Compound 1 or Compound 21 with cyproconazole, combinations of Compound 1 or Compound 21 with difenoconazole, combinations of Compound 1 or Compound 21 with epoxyconazole, combinations of Compound 1 or Compound 21 with flusilazole, combinations of Compound 1 or Compound 21 with ipconazole, combinations of Compound 1 or Compound 21 with metconazole, combinations of Compound 1 or Compound 21 with propiconazole, combinations of Compound 1 or Compound 21 with tebuconazole, combinations of Compound 1 or Compound 21 with triticonazole, combinations of Compound 1 or Compound 21 with famoxadone, combinations of Compound 1 or Compound 21 with fenamidone, combinations of Compound 1 or Compound 21 with benomyl, combinations of Compound 1 or Compound 21 with cymoxanil, combinations of Compound 1 or Compound 21 with fosetyl-aluminum, combinations of Compound 1 or Compound 21 with metalaxyl, combinations of Compound 1 or Compound 21 with propineb, combinations of Compound 1 or Compound 21 with zineb, combinations of Compound 1 or Compound 21 with copper sulfate, combinations of Compound 1 or Compound 21 with copper hydroxide, combinations of Compound 1 or Compound 21 with propamocarb, combinations of Compound 1 or Compound 21 with cyazofamid, combinations of Compound 1 or Compound 21 with zoxamid, combinations of Compound 1 or Compound 21 with fluazinam and combinations of Compound 1 or Compound 21 with iprovalicarb. Compound numbers refer to compounds in Index Table A.

Formulation/Utility

Compositions of this invention will generally be used as a formulation or composition comprising at least one carrier selected from agriculturally suitable liquid diluents, solid diluents and surfactants. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts (e.g. from 0.01-99.99 weight percent) of active ingredients together with diluent and/or surfactant within the following approximate ranges which add up to 100 percent by weight.

| | Weight Percent | | |
|---|---|---|---|
| | Active | | |
| | Ingredients | Diluent | Surfactant |
| Water-Dispersible and | 5-90 | 0-94 | 1-15 |
| Water-soluble Granules, | | | |
| Tablets and Powders. | | | |
| Suspensions, Emulsions, | 5-50 | 40-95 | 0-25 |
| Solutions (including | | | |
| Emulsifiable Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Preferred suspension concentrates include those containing, in addition to the active ingredient, from 5 to 20% nonionic surfactant (for example, polyethoxylated fatty alcohols) optionally combined with 50-65% liquid diluents and up to 5% anionic surfactants. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

In the following Examples, all percentages are by weight and all formulations are prepared in conventional ways. Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except where otherwise indicated.

### EXAMPLE A

Wettable Powder

| | |
|---|---|
| Active ingredients | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE B

Granule

| | |
|---|---|
| Active ingredients | 10.0% |
| attapulgite granules (low volatile matter, | 90.0%. |
| 0.71/0.30 mm; U.S.S. No. 25-50 sieves) | |

### EXAMPLE C

Extruded Pellet

| | |
|---|---|
| Active ingredients | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE D

Emulsifiable Concentrate

| | |
|---|---|
| Active ingredients | 20.0% |
| blend of oil soluble sulfonates | 10.0% |
| and polyoxyethylene ethers | |
| isophorone | 70.0%. |

### EXAMPLE E

Suspension Concentrate

| | | |
|---|---|---|
| Active ingredients | | 20.0% |
| polyethoxylated fatty alcohol | nonionic surfactant | 15.0% |
| ester derivative of montan wax | | 3.0% |
| calcium lignosulfonate | anionic surfactant | 2.0% |
| polyethoxylated/polypropoxylated | | |
| polyglycol block copolymer | surfactant | 1.0% |
| propylene glycol | diluent | 6.4% |
| poly(dimethylsioxane) | antifoam agent | 0.6% |
| antimicrobial agent | | 0.1% |
| water | diluent | 51.9% |

The formulation ingredients are mixed together as a syrup, the active ingredients are added and the mixture is homogenized in a blender. The resulting slurry is then wet-milled to form a suspension concentrate.

Compositions of this invention can also be mixed with one or more insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection. Examples of such agricultural protectants with which compositions of this invention can be formulated are: insecticides such as abamectin, acephate, azinphos-methyl bifenthrin, buprofezin, carbofuran, chlorfenapyr, chlorpyrifos, chlorpyrifos-methyl cyfluthrin, beta-cyfluthrin, cyhalothrin, lambda-cyhalothrin, deltamethrin, diafenthiuron, diazinon, diflubenzuron, dimethoate, esfenvalerate, fenoxycarb, fenpropathrin, fenvalerate, fipronil, flucythrinate, tau-fluvalinate, fonophos, imidacloprid, isofenphos, malathion, metaldehyde, methamidophos, methidathion, methomyl, methoprene, methoxychlor, methyl 7-chloro-2,5-dihydro-2-[[N-(methoxycarbonyl)-N-[4-(trifluoromethoxy)phenyl]amino]carbonyl]indeno[1,2-e][1,3,4]oxadiazine-4a(3H)-carboxylate (indoxacarb), monocrotophos, oxamyl, parathion, parathion-methyl, permethrin, phorate, phosalone, phosmet, phosphamidon, pirimicarb, profenofos, rotenone, sulprofos, tebufenozide, tefluthrin, terbufos, tetrachlorvinphos, thiodicarb, tralomethrin, trichlorfon and triflumuron; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; nematocides such as aldoxycarb and fenamiphos; and biological agents such as Bacillus thuringiensis, Bacillus thuringiensis delta endotoxin, baculovirus, and entomopathogenic bacteria, virus and fungi. The weight ratios of these various mixing partners to compounds of Formula I of this invention typically are between 100:1 and 1:100, preferably between 30:1 and 1:30, more preferably between 10:1 and 1:10 and most preferably between 4:1 and 1:4.

The compositions of this invention are useful as plant disease control agents. The present invention therefore further comprises a method for controlling plant diseases caused by fungal plant pathogens comprising applying to the plant or portion thereof to be protected, or to the plant seed or seedling to be protected, an effective amount of a compound of the invention or a fungicidal composition containing said compound. The compounds and compositions of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, vegetable, field, cereal, and fruit crops. These pathogens include Plasmopara viticola, Phytophthora infestans, Peronospora tabacina, Pseudoperonospora cubensis, Pythium aphanidermatum, Alternaria brassicae, Septoria nodorum, Septoria tritici, Cercosporidium personatum, Cercospora arachidicola, Pseudocercosporella herpotrichoides, Cercospora beticola, Botrytis cinerea, Monilinia fructicola, Pyrcularia oryzae, Podosphaera leucotricha, Venturia inaequalis, Erysiphe graminis, Uncinula necatur, Puccinia recondita, Puccinia graminis, Hemileia vastatrix, Puccinia striiformis, Puccinia arachidis, Rhizoctonia solani, Sphaerotheca fuliginea, Fusarium oxysporum, Verticillium dahliae, Pythium aphanidermatum, Phytophthora megasperma, Sclerotinia sclerotiorum, Sclerotium rolfsii, Erysiphe polygoni, Pyrenophora teres, Gaeumannomyces graminis, Rynchosporium secalis, Fusarium roseum, Bremia lactucae and other generea and species closely related to these pathogens. The compositions of the invention are especially effective in controlling Plasmopara viticola on grapes and Phytophthora infestans on potatoes and tomatoes.

Plant disease control is ordinarily accomplished by applying an effective amount of a composition of this invention either pre- or post-infection, to the portion of the plant to be protected such as the roots, stems, foliage, fruit, seeds, tubers or bulbs, or to the media (soil or sand) in which the plants to be protected are growing. The compounds can also be applied to the seed to protect the seed and seedling.

Rates of application for these compositions can be influenced by many factors of the environment and should be determined under actual use conditions. Foliage can normally be protected when treated at a rate of from less than 1 g/ha to 5,000 g/ha of active ingredient. Seed and seedlings can normally be protected when seed is treated at a rate of from 0.1 to 10 g per kilogram of seed.

The following TESTS demonstrate the control efficacy of compounds comprising component (a) of this invention on specific pathogens. The pathogen control protection afforded by the compositions is not limited, however, to these species. See Index Tables A-B for compound descriptions for component (a) used in the TESTS. The following abbreviations are used in the Index Tables that follow: Me is methyl, OMe is methoxy and OEt is ethoxy. The abbreviation “Ex.” stands for “Example” and is followed by a number indicating in which example the compound is prepared.

INDEX TABLE A

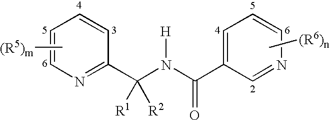

| | | | | | m.p. |
|---|---|---|---|---|---|
| Compound Number | R¹ | R² | (R⁵)ₘ | (R⁶)ₙ | (° C.) |
| 1 | H | H | 3-Cl-5-CF₃ | 2,6-Cl₂ | 110- |
| | | | | | 111 |
| 2 | H | H | 3-Cl-5-CF₃ | 2-Cl | * |
| 3 | H | H | 3-Cl-5-CF₃ | 6-Cl | |
| 4 | H | H | 3-Cl-5-CF₃ | 5,6-Cl₂ | * |
| 5 (Ex. 1) | H | H | 3-Cl-5-CF₃ | 2,4-Cl₂-6-Me | * |
| 6 | H | H | 3-Cl-5-CF₃ | 2-NH₂ | |
| 7 | H | H | 3-Cl-5-CF₃ | 5-Br | |
| 8 | H | H | 3-Cl-5-CF₃ | 2-OH | |
| 9 | H | H | 3-Cl-5-CF₃ | 2-OMe | |
| 10 | H | H | 3-Cl-5-CF₃ | 2-OEt | |
| 11 | H | H | 3-Cl-5-CF₃ | 2-Cl-6-Me | |
| 12 | H | H | 3-Cl-5-CF₃ | 2-Br-6-CF₃ | * |
| 13 | H | H | 3-Cl-5-CF₃ | 2-OH-6-Me | * |
| 14 | H | H | 3-Cl-5-CF₃ | 2-Me-6-CF₃ | * |
| 15 | H | H | 3-Cl-5-CF₃ | 2-Me-6-CF₂CF₃ | * |
| 16 | H | H | 3-Cl-5-CF₃ | 2-OMe-6-CF₃ | * |
| 17 | H | H | 3-Cl-5-CF₃ | 2-Me-6-Cl | * |
| 18 | H | H | 3-Cl-5-CF₃ | 6-CF₃ | * |
| 19 (Ex. 2) | H | H | 3-Cl-5-CF₃ | 2,4-Cl₂ | 122- |
| | | | | | 124 |
| 20 | H | H | 3-Cl-5-CF₃ | 2,4-Cl₂-5-Me | * |
| 21 (Ex. 3) racemic | H | CH₃ | 3-Cl-5-CF₃ | 2,4-Cl₂ | * |
| 22 (Ex. 4) | H | CH₃ | 3-Cl-5-CF₃ | 2,4-Cl₂ | 110- |
| (+)-enantiomer | | | | | 111 |
| 23 (−)-enantiomer | H | CH₃ | 3-Cl-5-CF₃ | 2,4-Cl₂ | * |

*See Index TABLE B for ¹H NMR data.

INDEX TABLE B

| Cmpd No. | ¹H NMR Data (300 mHz; CDCl₃ solution unless indicated otherwise)^{a} |
|---|---|
| 2 | δ 4.95(m, 2H), 7.44(m, 1H), 8.0(s, 1H), 8.2-8.3(m, 2H), 8.5(m, 1H), 8.8(m, 1H) |
| 4 | (DMSO-d₆) δ 4.8(m, 2H), 8.54(s, 1H), 8.55(s, 1H), 8.84(s, 1H), 8.9(s, 1H), 9.5(bs, 1H) |
| 5 | δ 2.57(s, 3H), 4.96(m, 2H), 7.22(s, 1H), 7.48(bs, 1H), 8.00(s, 1H), 8.71(s, 1H) |
| 12 | δ 4.95(m, 2H), 7.76(m, 1H), 7.94(bs, 1H), 8.00(s, 1H), 8.16(m, 1H), 8.74(s, 1H) |
| 13 | (DMSO-d₆) δ 2.30(s, 3H), 4.8(m, 2H), 6.3(m, 1H), 8.2(m, 1H), 8.47(s, 1H), 8.93(s, 1H), 10.4 |
| | (m, 1H), 12.4(bs, 1H) |
| 14 | δ 2.80(s, 3H), 4.94(m, 2H), 7.4(bs, 1H), 7.6(m, 1H), 8.0(m, 2H), 8.73(s, 1H) |
| 15 | δ 2.80(s, 3H), 4.95(m, 2H), 7.4(bs, 1H), 7.6(m, 1H), 8.0(m, 2H), 8.72(s, 1H) |
| 16 | δ 4.97(m, 2H), 7.44(m, 1H), 7.99(s, 1H), 8.71(m, 1H), 8.80(s, 1H), 9.42(bs, 1H) |
| 17 | δ 2.73(s, 3H), 4.91(m, 2H), 7.25(m, 1H), 7.4(bs, 1H), 7.8(m, 1H), 8.00(s, 1H), 8.73(s, 1H) |
| 18 | δ 4.94(m, 2H), 7.80(m, 1H), 7.9(bs, 1H), 8.0(s, 1H), 8.40(m, 1H), 8.77(s, 1H), 9.22(s, 1H) |
| 19 | (DMSO-d₆) δ 4.8(m, 2H), 7.0(m, 1H), 7.3(m, 1H), 7.3(m, 1H), 7.5(m, 1H), 7.8(m, 1H), 8.3 |
| | (m, 2H), 8.4(m, 1H), 8.5(s, 1H), 8.9(s, 1H), 9.5(m, 1H) |
| 20 | δ 1.62(d, 3H, J is 6.7Hz), 5.84(m, 1H), 7.35(d, 1H, J is 5.2Hz), 7.40(d, 1H, J is 6.9Hz), 7.99 |
| | (d, 1H, J is 1.8Hz), 8.34(d, 1H, J is 5.2Hz), 8.70(s, 1H) |
| 21 | δ 1.58(d, 3H, J is 6.6Hz), 5.7-5.8(m, 1H), 7.4(m, 2H), 7.77(m, 1H), 8.35(m, 1H), 8.40(m, 1H). |
| 22 | δ 1.62(d, 3H, J is 6.7Hz), 5.48(m, 1H), 7.35(d, 1H, J is 5.2Hz), 7.40(d, 1H, J is 6.9), 7.99(d, 1H, J |
| | is 1.8Hz), 8.34(d, 1H, J is 5.2), 8.70(s, 1H). |

^{a1}H NMR data are in ppm downfield from tetramethylsilane. Couplings are designated by (s)-singlet, (d)-doublet, (t)-triplet, (q)-quartet, (m)-multiplet, (dd)-doublet of doublets, (dt)-doublet of triplets, (br s)-broad singlet.

### BIOLOGICAL EXAMPLES OF THE INVENTION

General protocol for preparing test suspensions: Test compounds are first dissolved in acetone in an amount equal to 3% of the final volume and then suspended at the desired concentration (in ppm) in acetone and purified water (50/50 mix) containing 250 ppm of the surfactant Trem® 014 (polyhydric alcohol esters). The resulting test suspensions are then used in the following tests. Spraying a 200 ppm test suspension to the point of run-off on the test plants is the equivalent of a rate of 500 g/ha.

### Test A

The test suspension was sprayed to the point of run-off on wheat seedlings. The following day the seedlings were inoculated with a spore dust of Erysiphe graminis f. sp. tritici, (the causal agent of wheat powdery mildew) and incubated in a growth chamber at 20° C. for 7 days, after which disease ratings were made.

### Test B

The test suspension was sprayed to the point of run-off on wheat seedlings. The following day the seedlings were inoculated with a spore suspension of Puccinia recondita (the causal agent of wheat leaf rust) and incubated in a saturated atmosphere at 20° C. for 24 h, and then moved to a growth chamber at 20° C. for 6 days, after which disease ratings were made.

### Test C

The test suspension was sprayed to the point of run-off on rice seedlings. The following day the seedlings were inoculated with a spore suspension of Pyricularia oryzae (the causal agent of rice blast) and incubated in a saturated atmosphere at 27° C. for 24 h, and then moved to a growth chamber at 30° C. for 5 days, after which disease ratings were made.

### Test D

The test suspension was sprayed to the point of run-off on tomato seedlings. The following day the seedlings were inoculated with a spore suspension of Phytophthora infestans (the causal agent of potato and tomato late blight) and incubated in a saturated atmosphere at 20° C. for 24 h, and then moved to a growth chamber at 20° C. for 5 days, after which disease ratings were made.

### Test E

The test suspension was sprayed to the point of run-off on grape seedlings. The following day the seedlings were inoculated with a spore suspension of Plasmopara viticola (the causal agent of grape downy mildew) and incubated in a saturated atmosphere at 20° C. for 24 h, moved to a growth chamber at 20° C. for 6 days, and then incubated in a saturated atmosphere at 20° C. for 24 h, after which disease ratings were made.

### Test F

Tomato (or potato) seedlings are inoculated with a spore suspension of Phytophthora infestans (the causal agent of potato and tomato late blight) and incubated in a saturated atmosphere at 20° C. for 24 h. The next day, test suspension is sprayed to the point of run-off and the treated plants are moved to a growth chamber at 20° C. for 5 days, after which disease ratings are made.

### Test G

Grape seedlings are inoculated with a spore suspension of Plasmopara viticola (the casual agent of grape downy mildew) and incubated in a saturated atmosphere at 20° C. for 24 h. The next day, test suspension is sprayed to the point of run-off and the treated plants are moved to a growth chamber at 20° C. for 6 days, and then incubated in a saturated atmosphere at 20° C. for 24 h, after which disease ratings are made.

Results for Tests A-E are given in Table A. In the table, a rating of 100 indicates 100% disease control and a rating of 0 indicates no disease control (relative to the controls). A dash (-) indicates no test results. In addition to the Tests shown below, compounds 2, 5, 19, 20, 21 and 22 are considered to have significant curative utility, especially for grape downy mildew.

TABLE A

| Cmpd | Test | | | | | | |
|---|---|---|---|---|---|---|---|
| No. | A | Test B | Test C | Test D | Test E | Test F | Test G |
| 1 | — | — | — | 99 | — | — | — |
| 2 | — | 19 | — | — | 98 | 9# | 99 |
| 3 | 0 | 0 | — | 19 | — | — | — |
| 4 | 0 | 0 | — | — | — | — | 0 |
| 5 | 0 | 8 | — | 100 | 100 | 100# | 96 |
| 6 | 0 | 28 | 0 | 7 | 0 | — | 8 |
| 7 | 0 | 9 | 74 | 16 | 0 | — | 0 |
| 8 | 0 | 9 | 0 | 7 | 8 | — | 8 |
| 9 | 0 | 19 | 0 | 7 | 24 | — | 24 |
| 10 | 0 | 9 | 0 | 3 | 23 | — | 23 |
| 11 | 0 | 19 | 90 | 100 | 98 | 0 | 99 |
| 12 | 0 | 9 | 80 | 32 | 0 | — | 0 |
| 13 | 0 | 9 | 0 | 7 | 8 | — | 8 |
| 14 | 0 | 28 | 87 | 25 | 8 | — | 8 |
| 15 | 69 | 68 | 88 | 16 | 8 | — | 8 |
| 16 | 0 | 0 | 0 | 7 | 0 | — | 0 |
| 17 | 0 | 9 | 13 | 79 | 16 | — | 16 |
| 18 | 0 | 32 | 0 | 25 | 0 | — | 0 |
| 19 | 0 | 35 | 0 | 100 | 100 | 97# | 37* |
| 20 | 0 | 54 | 0 | 100 | 100 | 24# | 100* |
| 21 | 0 | 74 | 0 | 100 | 100 | 100# | 100* |
| 22 | — | — | 0 | 100 | 100 | 100# | 100** |
| 23 | — | — | — | — | 69* | 65# | 0** |

#100 ppm on potato seedlings
*100 ppm.
**20 ppm.

Synergism has been described as “the cooperative action of two components of a mixture, such that the total effect is greater or more prolonged than the sum of the effects of the two (or more) taken independently” (see Tames, P. M. L., Neth. J. Plant Pathology, 1964, 70, 73-80). It is found that compositions containing the compound of Formula I and fungicides with a different mode of action exhibit synergistic effects.

The presence of a synergistic effect between two active ingredients is established with the aid of the Colby equation (see Colby, S. R. In Calculating Synergistic and Antagonistic Responses of Herbicide Combinations, Weeds, 1967, 15, 20-22):

$$p = A + B - [ \frac{A \times B}{100} ]$$

Using the methods of Colby, the presence of a synergistic interaction between two active ingredients is established by first calculating the predicted activity, p, of the mixture based on activities of the two components applied alone. If p is lower than the experimentally established effect, synergism has occurred. In the equation above, A is the fungicidal activity in percentage control of one component applied alone at rate x. The B term is the fungicidal activity in percentage control of the second component applied at rate y. The equation estimates p, the fungicidal activity of the mixture of A at rate x with B at rate y if their effects are strictly additive and no interaction has occurred.

The following TESTS can be used to demonstrate the control efficacy of compositions of this invention on specific pathogens. The pathogen control protection afforded by the compounds is not limited, however, to these species.

Test suspensions comprising a single active ingredient are sprayed to demonstrate the control efficacy of the active ingredient individually. To demonstrate the control efficacy of a combination, (a) the active ingredients can be combined in the appropriate amounts in a single test suspension, (b) stock solutions of individual active ingredients can be prepared and then combined in the appropriate ratio, and diluted to the final desired concentration to form a test suspension or (c) test suspensions comprising single active ingredients can be sprayed sequentially in the desired ratio.

| | |
|---|---|
| Ingredients | Wt. % |

Composition 1

| | |
|---|---|
| Compound 21 Technical Material | 20 |
| Polyethoxylated stearyl alcohol | 15 |
| Montan wax ester | 3 |
| Desugared calcium lignosulfate | 2 |
| Polyoxypropylene-polyoxyethylene block copolymer | 1 |
| Propylene Glycol | 6.4 |
| Polyorganosiloxanes + emulsifying agent | 0.6 |
| 19% (1,2-benzisothiazolin-3-one) in aqueous dipropylene glycol | 0.1 |
| Water | 51.9 |

Composition 2

| | |
|---|---|
| Compound 1 Technical Material | 20 |
| Polyethoxylated stearyl alcohol | 15 |
| Montan wax ester | 3 |
| Desugared calcium lignosulfate | 2 |
| Polyoxypropylene-polyoxyethylene block copolymer | 1 |
| Propylene Glycol | 6.4 |
| Polyorganosiloxanes + emulsifying agent | 0.6 |
| 19% (1,2-benzisothiazolin-3-one) in aqueous dipropylene glycol | 0.1 |
| Water | 51.9 |

Composition 3

| | |
|---|---|
| Mancozeb tech. | 82.3 |
| zinc sulfate monohydrate | 2.7 |
| sodium lignosulfonate | 9.0 |
| sodium alkylnaphthalene sulfonate | 1.5 |
| sodium dodecylbenzene sulfonate | 1.5 |
| hexamethylenetetramine | 1.5 |
| sucrose | 1.5 |

Composition 4

| | |
|---|---|
| Famoxadone Technical Material | 51.7 |
| Sodium lignosulfate | 36.0 |
| Sodium alkylnaphthalene sulfonate | 2.0 |
| Polyvinyl pyrrolidone | 4.0 |
| Polyoxypropylene-polyoxyethylene block copolymer | 3.0 |
| Sodium dodecylbenzene sulfonate | 3.0 |
| Fluoroalkyl acid mixture | 0.3 |

Composition 5

| | |
|---|---|
| Cymoxanil Technical Material | 61.9 |
| Sodium alkylnaphthalene sulfonate formaldehyde condensate | 5.0 |
| Sodium alkylnaphthalene sulfonate | 1.0 |
| Polyvinyl pyrrolidone | 4.0 |
| Monosodium phosphate | 4.0 |
| Fumaric acid | 1.0 |
| Fumed silica | 1.0 |
| Sodium | 0.2 |
| Sugar | 14.0 |
| Sodium lignosulfate | 7.9 |

Test compositions were first mixed with purified water containing 250 ppm of the surfactant Trem® 014 (polyhydric alcohol esters). The resulting test suspensions were then used in the following tests. Test suspensions were sprayed to the point of run-off on the test plants at the equivalent rates of 5, 10, 20, 25, 50 or 100 g/ha of the active ingredient. Spraying a 40 ppm test suspension to the point of run-off on the test plants is the equivalent of a rate of 100 g/ha. The tests were replicated three times and the results reported as the average of the three replicates.

### Test H (Preventive Control of Phytophthora infestans)

The test suspension was sprayed to the point of run-off on Potato seedlings. The following day the seedlings were inoculated with a spore suspension of Phytophthora infestans (the causal agent of tomato and potato late blight) and incubated in a saturated atmosphere at 20° C. for 24 h and then moved to a growth chamber at 20° C. for 5 days, after which disease ratings were made.

### Test I (Curative Control of Phytophthora infestans)

Potato seedlings were inoculated with a spore suspension of Phytophthora infestans (the causal agent of tomato and potato late blight) 24 hours prior to application and incubated in a saturated atmosphere at 20° C. for 24 h. The test suspensions were then sprayed to the point of run-off on the potato seedlings. The following day the seedlings were moved to a growth chamber at 20° C. for 5 days, after which disease ratings were made.

### Test J (Extended Preventive Control of Phytophthora infestans)

The test suspensions was sprayed to the point of run-off on potato seedlings. Six days later, the seedlings were inoculated with a spore suspension of Phytophthora infestans (the causal agent of tomato and potato late blight) and incubated in a saturated atmosphere at 20° C. for 24 h, and then moved to a growth chamber at 20° C. for 5 days, after which disease ratings were made.

### Test K (Preventive Control of Plasmopara viticola)

The test suspension was sprayed to the point of run-off on grape seedlings. The following day the seedlings were inoculated with a spore suspension of Plasmopara viticola (the causal agent of grape downy mildew) and incubated in a saturated atmosphere at 20° C. for 24 h, moved to a growth chamber at 20° C. for 6 days, and then incubated in a saturated atmosphere at 20° C. for 24 h, after which disease ratings were made.

### Test L (Curative Control of Plasmopara viticola)

Grape seedlings were inoculated with a spore suspension of Plasmopara viticola (the causal agent of grape downy mildew) and incubated in a saturated atmosphere at 20° C. for 48 h, before the test suspension was sprayed to the point of run-off on grape seedlings. Plants were then moved to a growth chamber at 20° C. for 6 days, and then incubated in a saturated atmosphere at 20° C. for 24 h, after which disease ratings were made.

### Test M (Extended Preventive Control of Plasmopara viticola)

The test suspension was sprayed to the point of ran-off on grape seedlings. Five days later seedlings were inoculated with a spore suspension of Plasmopara viticola (the causal agent of grape downy mildew) and incubated in a saturated atmosphere at 20° C. for 48 h, moved to a growth chamber at 20° C. for 6 days, and then incubated in a saturated atmosphere at 20° C. for 24 h, after which disease ratings were made.

Results for Tests H-M are given in Table B. In the table, a rating of 100 indicates 100% disease control and a rating of 0 indicates no disease control (relative to the controls). Columns labeled Avg indicates the average of three replications. Columns labeled Exp indicate the expected value for each treatment mixture using the Colby equation. Tests demonstrating control greater than expected are indicated with *.

TABLE B

| Composition | | Test H | | Test I | | Test J | | Test K | | Test L | | Test M | |
|---|---|---|---|---|---|---|---|---|---|---|---|---|---|
| Number | Rate | Avg | Exp | Avg | Exp | Avg | Exp | Avg | Exp | Avg | Exp | Avg | Exp |
| 1 | 5 | 99 | xx | 0 | xx | 30 | xx | 83 | xx | 0 | xx | 13 | xx |
| 1 | 10 | 100 | xx | 0 | xx | 37 | xx | 97 | xx | 0 | xx | 73 | xx |
| 1 | 20 | 100 | xx | 0 | xx | 82 | xx | 100 | xx | 70 | xx | 73 | xx |
| 2 | 5 | 100 | xx | 0 | xx | 21 | xx | 65 | xx | 0 | xx | 13 | xx |
| 2 | 10 | 100 | xx | 0 | xx | 46 | xx | 73 | xx | 0 | xx | 67 | xx |
| 2 | 20 | 100 | xx | 0 | xx | 99 | xx | 92 | xx | 0 | xx | 73 | xx |
| 3 | 25 | 100 | xx | 0 | xx | 0 | xx | 88 | xx | 0 | xx | 29 | xx |
| 3 | 50 | 99 | xx | 0 | xx | 37 | xx | 98 | xx | 0 | xx | 78 | xx |
| 3 | 100 | 100 | xx | 0 | xx | 41 | xx | 100 | xx | 0 | xx | 99 | xx |
| 4 | 25 | 100 | xx | 0 | xx | 0 | xx | 66 | xx | 0 | xx | 97 | xx |
| 4 | 50 | 99 | xx | 0 | xx | 0 | xx | 99 | xx | 0 | xx | 99 | xx |
| 4 | 100 | 100 | xx | 0 | xx | 26 | xx | 88 | xx | 0 | xx | 99 | xx |
| 5 | 25 | 0 | xx | 0 | xx | 0 | xx | 68 | xx | 41 | xx | 1 | xx |
| 5 | 50 | 17 | xx | 0 | xx | 0 | xx | 98 | xx | 93 | xx | 22 | xx |
| 5 | 100 | 98 | xx | 0 | xx | 0 | xx | 100 | xx | 93 | xx | 29 | xx |
| 1 + 3 | 5 + 25 | 100 | 100 | 0 | 0 | 80* | 30 | 98 | 98 | 0 | 0 | 46 | 38 |
| 1 + 3 | 10 + 50 | 100 | 100 | 0 | 0 | 93* | 60 | 100 | 100 | 0 | 0 | 100 | 94 |
| 1 + 3 | 20 + 100 | 100 | 100 | 0 | 0 | 100* | 89 | 100 | 100 | 16 | 70 | 100 | 100 |
| 1 + 4 | 5 + 25 | 100 | 100 | 0 | 0 | 50* | 30 | 88 | 94 | 0 | 0 | 91 | 98 |
| 1 + 4 | 10 + 50 | 100 | 100 | 0 | 0 | 51* | 37 | 100 | 100 | 0 | 0 | 99 | 100 |
| 1 + 4 | 20 + 100 | 100 | 100 | 0 | 0 | 97* | 87 | 100 | 100 | 0 | 70 | 100 | 100 |
| 1 + 5 | 5 + 25 | 100 | 99 | 0 | 0 | 31 | 30 | 87 | 94 | 32 | 41 | 58* | 14 |
| 1 + 5 | 10 + 50 | 100 | 100 | 69* | 0 | 51* | 37 | 100 | 100 | 98 | 93 | 99* | 79 |
| 1 + 5 | 20 + 100 | 100 | 100 | 99* | 0 | 100* | 82 | 100 | 100 | 100 | 98 | 100* | 81 |
| 2 + 3 | 5 + 25 | 100 | 100 | 0 | 0 | 74* | 21 | 73 | 96 | 0 | 0 | 73* | 38 |
| 2 + 3 | 10 + 50 | 100 | 100 | 0 | 0 | 75* | 66 | 93 | 100 | 0 | 0 | 91 | 93 |
| 2 + 3 | 20 + 100 | 100 | 100 | 0 | 0 | 88* | 99 | 94 | 100 | 24 | 0 | 97 | 100 |
| 2 + 4 | 5 + 25 | 100 | 100 | 0 | 0 | 51* | 21 | 73 | 88 | 0 | 0 | 78 | 98 |
| 2 + 4 | 10 + 50 | 100 | 100 | 0 | 0 | 58* | 46 | 83 | 100 | 0 | 0 | 98 | 100 |
| 2 + 4 | 20 + 100 | 100 | 100 | 0 | 0 | 100 | 99 | 94 | 99 | 0 | 0 | 97 | 100 |
| 2 + 5 | 5 + 25 | 100 | 100 | 0 | 0 | 0 | 21 | 70 | 89 | 98* | 41 | 42* | 14 |
| 2 + 5 | 10 + 50 | 100 | 100 | 31* | 0 | 47 | 46 | 100 | 99 | 94 | 93 | 91* | 74 |
| 2 + 5 | 20 + 100 | 100 | 100 | 71* | 0 | 88 | 99 | 100 | 100 | 100 | 93 | 98 | 81 |

Based on the description of synergism developed by Colby, compositions of the present invention are illustrated to be synergistically useful. Moreover, compositions comprising components (a) and (b) alone can be conveniently mixed with an optional diluent prior to applying to the crop to be protected Accordingly, this invention provides an improved method of combating fungi, particularly fungi of the class Oomycetes such as Phytophthora spp. and Plasmopara spp., in crops, especially potatoes, grapes and tomatoes.

1. A composition for controlling plant diseases caused by fungal plant pathogens comprising:
(a) at least one compound of Formula I, N-oxides and agriculturally suitable salts thereof 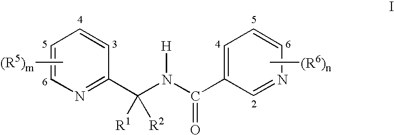
wherein
R¹ and R² are each independently H or C₁-C₆ alkyl;
each R⁵ is independently C₁-C₆ alkyl, C₂-C₆ alkenyl, C₂-C₆ alkynyl, C₃-C₆ cycloalkyl C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl; provided that at least one R⁵ is C₁ to C₆ haloalkyl;
each R⁶ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl; and
m and n are independently 1, 2, 3 or 4; and
(b) at least one compound selected from the group consisting of
(b1) alkylenebis(dithiocarbamate) fungicides;
(b2) compounds acting at the bc, complex of the fungal mitochondrial respiratory electron transfer site;
(b3) cymoxanil;
(b4) compounds acting at the demethylase enzyme of the sterol biosynthesis pathway;
(b5) morpholine and piperidine compounds that act on the sterol biosynthesis pathway;
(b6) phenylamide fungicides;
(b7) pyrimidinone fungicides;
(b8) phthalimides; and
(b9) fosetyl-aluminum.

2. The composition of claim 1 wherein the weight ratio of component (b) to component (a) is from 9:1 to 4.5:1.

3. The composition of claim 2 wherein component (b) is cymoxanil.

4. The composition of claim 2 wherein component (b) is a compound selected from (b1).

5. The composition of claim 4 wherein component (b) is mancozeb.

6. The composition of claim 2 wherein component (b) is a compound selected from (b2).

7. The composition of claim 6 wherein component (b) is famoxadone.

8. The composition of claim 1 wherein component (b) comprises at least one compound from each of two different groups selected from (b1), (b2), (b3), (b4), (b5), (b6), (b7), (b8) and (b9).

9. The composition of claim 8 wherein component (b) comprises at least one compound selected from (b1) and at least one compound selected from (b2), (b3), (b6), (b7), (b8) or (b9); wherein the overall weight ratio of component (b) to component (a) is from 30:1 to 1:30; and wherein the weight ratio of component (b1) to component (a) is from 10:1 to 1:1.

10. The composition of claim 8 wherein component (b) comprises at least one compound selected from (b2) and at least one compound selected from (b1), (b3), (b6), (b7), (b8) or (b9); wherein the overall weight ratio of component (b) to component (a) is from 30:1 to 1:30; and wherein the weight ratio of component (b2) to component (a) is from 10:1 to 1:1.

11. The composition of claim 8 wherein component (b) comprises cymoxanil and at least one compound selected from (b1), (b2), (b6), (b7), (b8) or (b9); wherein the overall weight ratio of component (b) to component (a) is from 30:1 to 1:30; and wherein the weight ratio of cymoxanil to component (a) is from 10:1 to 1:1.

12. A method for controlling plant diseases caused by fungal plant pathogens comprising applying to the plant or portion thereof, or to the plant seed or seedling, a fungicidally effective amount of a composition of claim 1.

13. The method of claim 12 wherein the disease to be controlled is caused by the fungal pathogen Phytophthora infestans.

14. The method of claim 12 wherein the disease to be controlled is caused by the fungal pathogen Plasmopara viticola.
